(19) United States
(12) Patent Application Publication
(10) Pub. No.: US 2005/0177377 A1
(43) Pub. Date: Aug. 11, 2005

(54) Generation of subsystems

(75) Inventor: Edmund Elsper Beowulf Wright, Luton (GB)

Correspondence Address: BURNS DOANE SWECKER & MATHIS L L P, POST OFFICE BOX 1404, ALEXANDRIA, VA, 22313-1404, US

(73) Assignee: BAE SYSTEMS plc, London (GB)

(21) Appl. No.: 10/512,680

(22) PCT Filed: Jul. 19, 2004
(86) PCT No.: PCT/GB04/03126

(30) Foreign Application Priority Data
Jul. 21, 2003 (GB) 0316985.1
Aug. 11, 2003 (GB) 0318741.6
Jul. 15, 2004 (GB) 0415873.9

(51) Int. Cl. G06F 17/60

(52) U.S. Cl. 705/1

(57) ABSTRACT

Described herein is a method for generating a subsystem that enables a base architecture (100) to be adapted for a plurality of different applications (112, 114, 116, 118). For example, the base architecture relates to a mission support system for a vehicle and the platforms comprise a number of different individual vehicles in which the mission support system for each individual vehicle will need to be interfaced with other systems in the vehicle, for example, its control system.

The present invention relates to the generation of subsystems and is more particularly concerned with the generation of such systems in a host application using a universal subsystem.

Conventionally, when a system is to be designed for a particular application, the design is developed from scratch as it is specific to that particular application. Due to the specificity of the design, it cannot be re-used for a new similar but different application in another environment. This inability to re-use the design results in further costs being incurred to generate the design for the new application in another environment.

It is therefore an object of the present invention to provide a system which allows the repackaging and re-implementation of parts of a previous design in a new similar application.

In accordance with the present invention, there is provided a method of generating a mission support system for a plurality of platforms, the method comprising the steps of:
a) defining a basic architecture for the mission support system;
b) deriving a universal subsystem from the architecture;
c) defining the universal subsystem in terms of a data model;
d) storing the data model in a relational database; and
e) interfacing with the relational database to adapt the mission support system for each of the platforms.

Advantageously, step a) includes deriving a plurality of key mechanisms that are characteristic of the basic architecture. Ideally, the key mechanisms comprise public key mechanisms and private key mechanisms, and at least one of the public key mechanisms can be accessed in step e).

In step d), the data model is stored in tables within the relational database. The tables include subsystem definition tables and subsystem data tables.

Additionally, step e) includes the steps of:

f) populating the subsystem definition tables;

g) populating the subsystem data tables;

h) deriving a graphical user interface; and

i) connecting the graphical user interface to the relational database.

Step f) includes the additional steps of:

j) selecting classes from the data model to add to the subsystem definition tables;

k) using a corresponding specification for each selected class to add a new entry in a class description table; and

l) for each attribute within a selected class, adding a new entry in a class attribute description table.

Step g) includes the additional step of making a database table for each of the classes specified in the class description table.

For a better understanding of the present invention, reference will now be made, by way of example only, to the accompanying drawings in which:

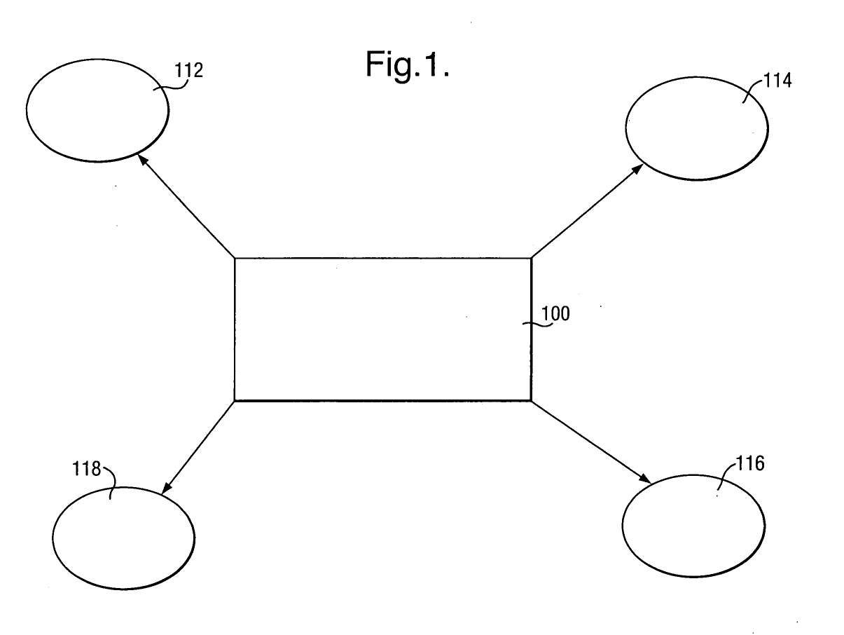

FIG. 1 is a block diagram illustrating an overall view of the system of the present invention;

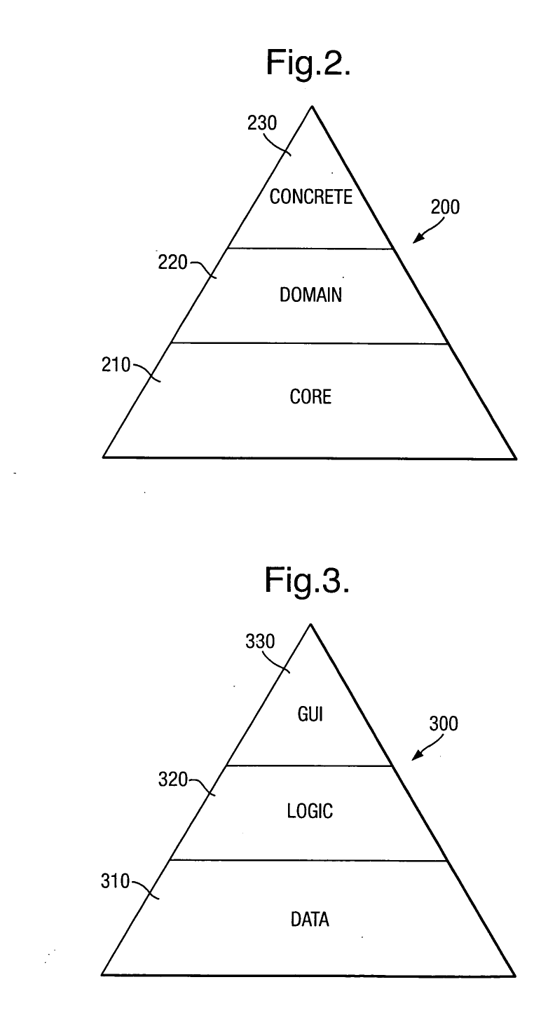

FIG. 2 is a diagram illustrating one representation of the system of the present invention;

FIG. 3 is a diagram illustrating a second representation of the system of the present invention;

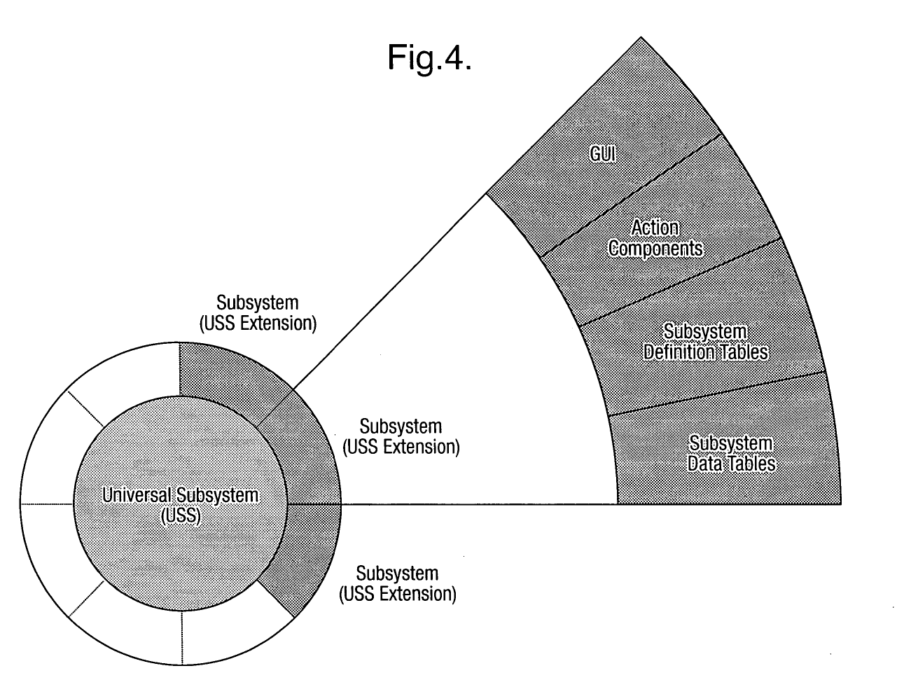

FIG. 4 illustrates a subsystem as being an extension of a universal subsystem;

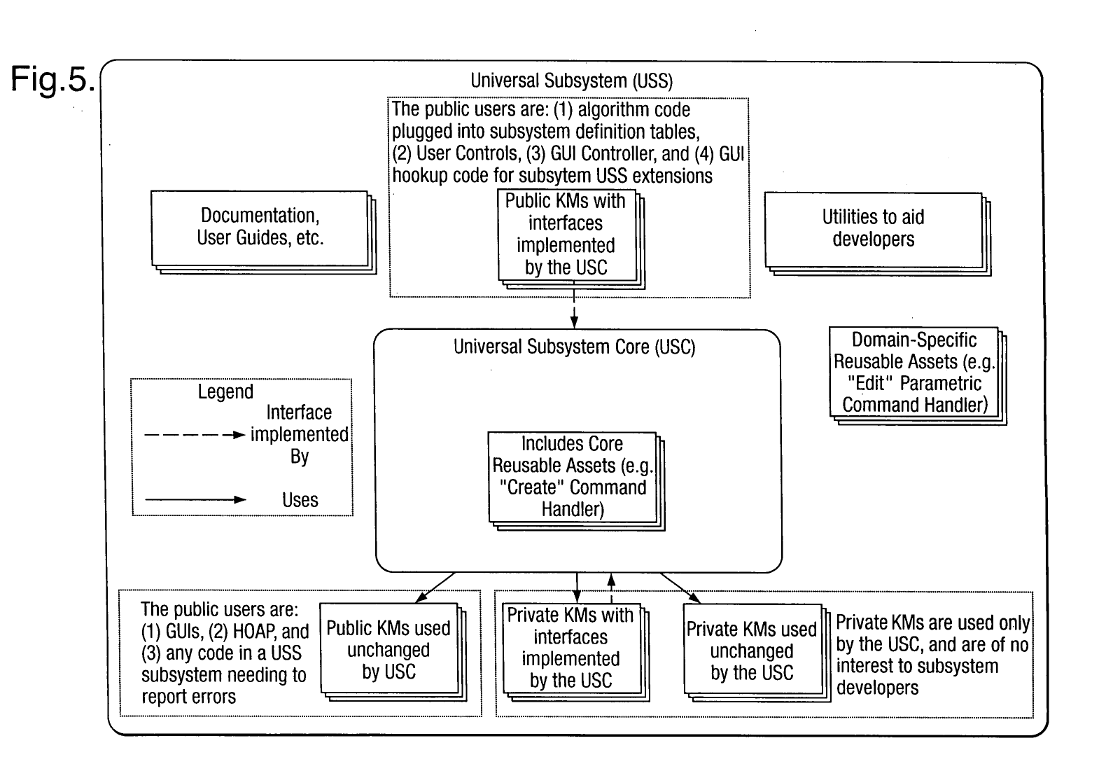

FIG. 5 illustrates an architectural overview of a universal subsystem in acccordance with the present invention;

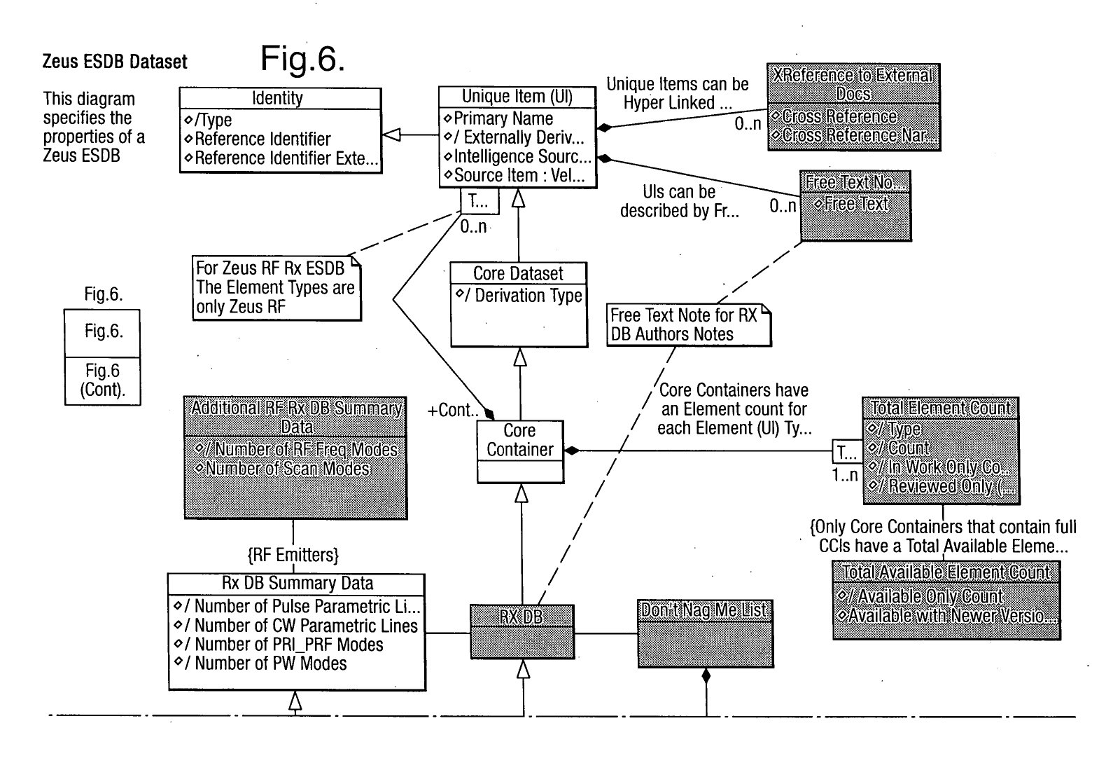

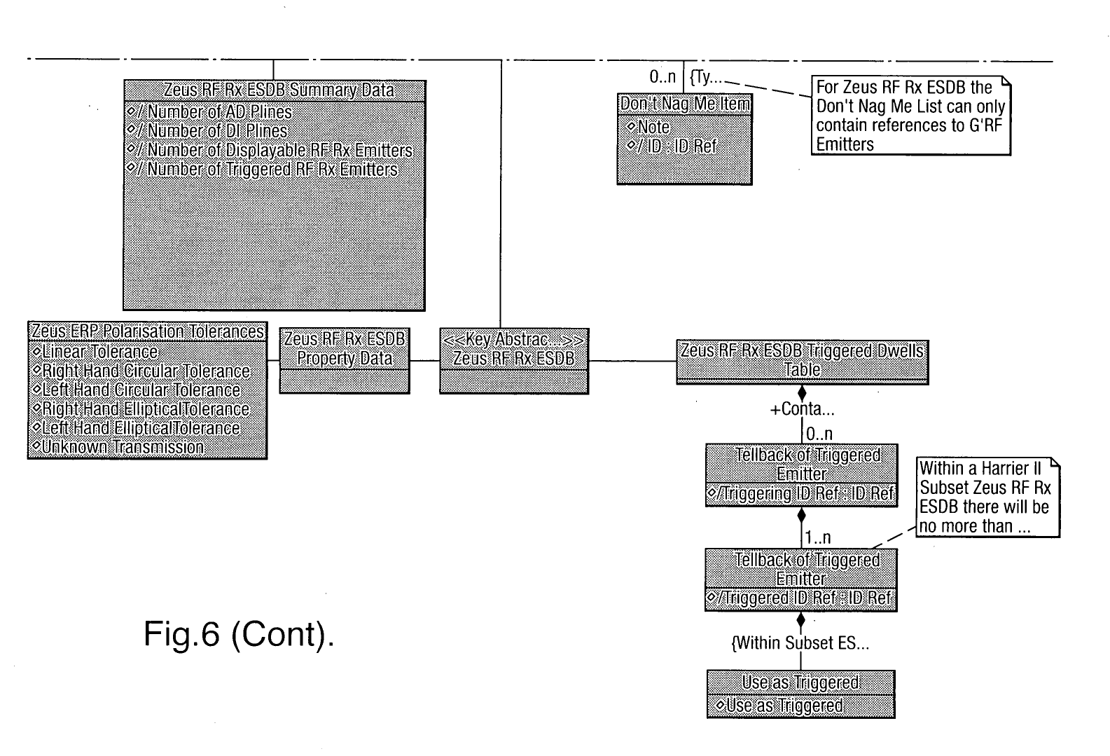

FIG. 6 illustrates the properties of a dataset;

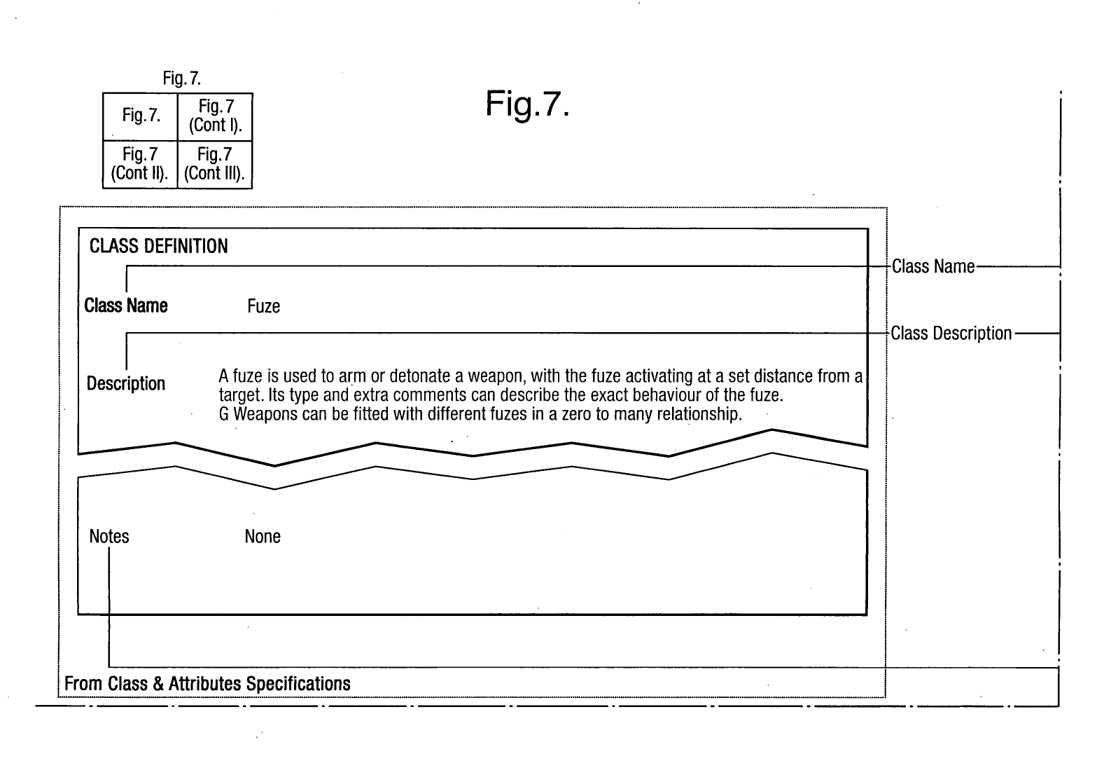

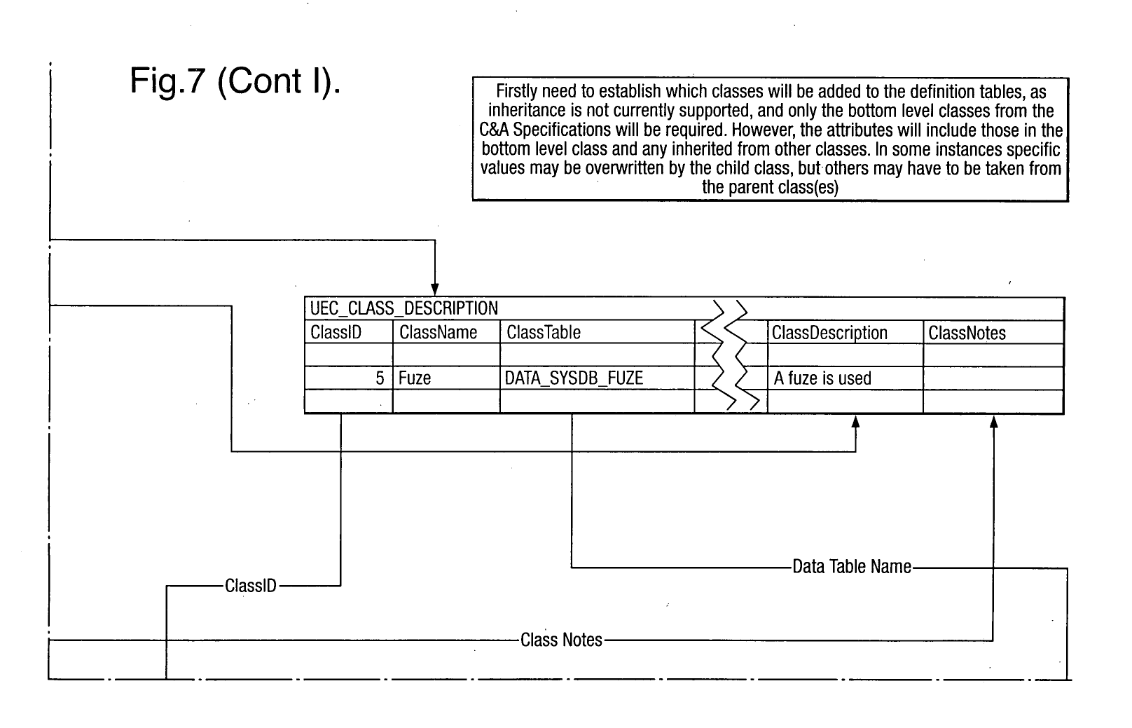

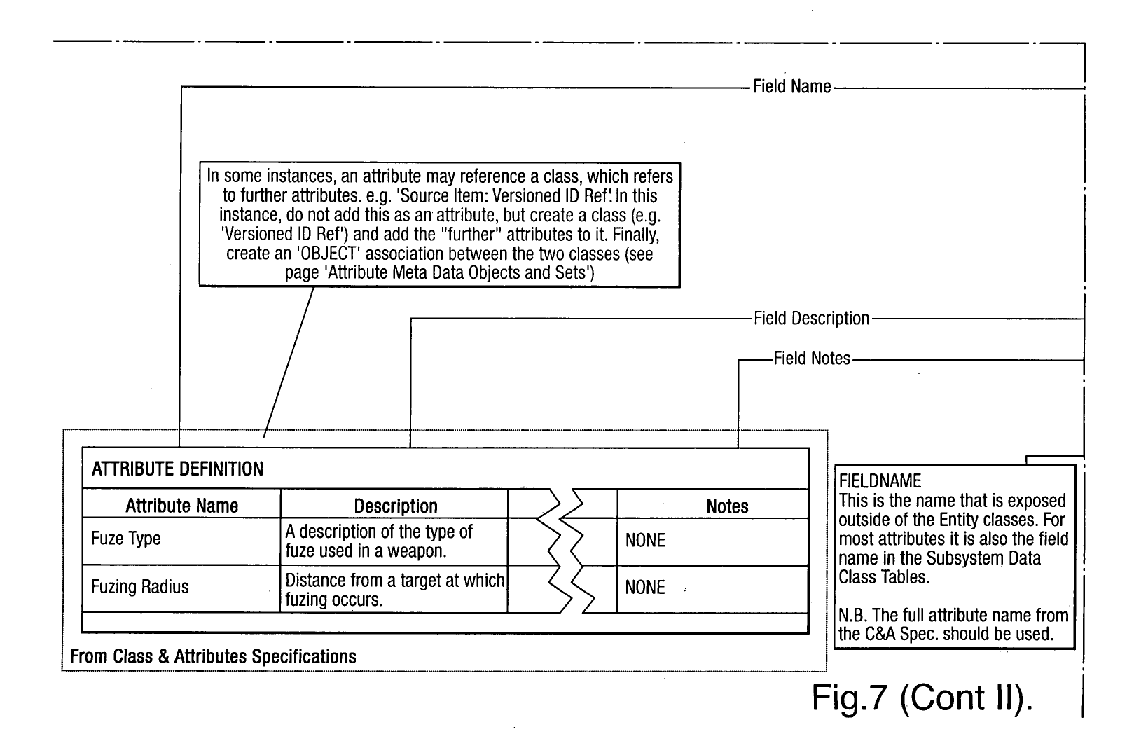

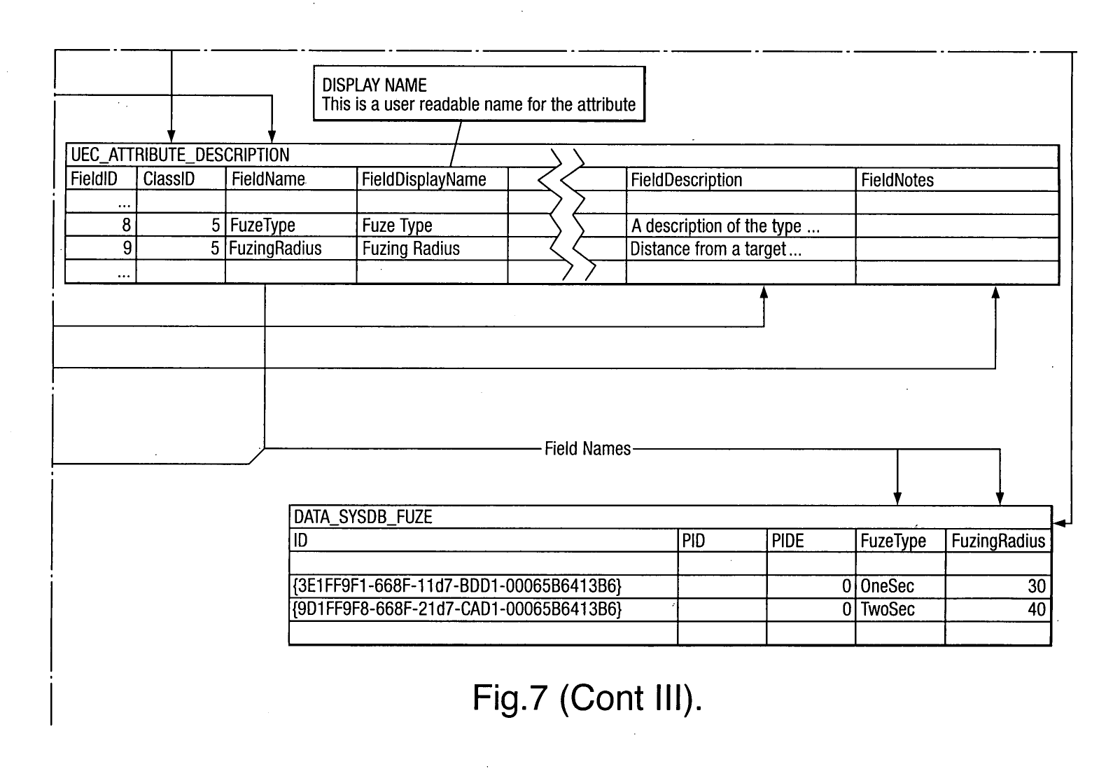

FIG. 7 illustrates Class and Attributes;

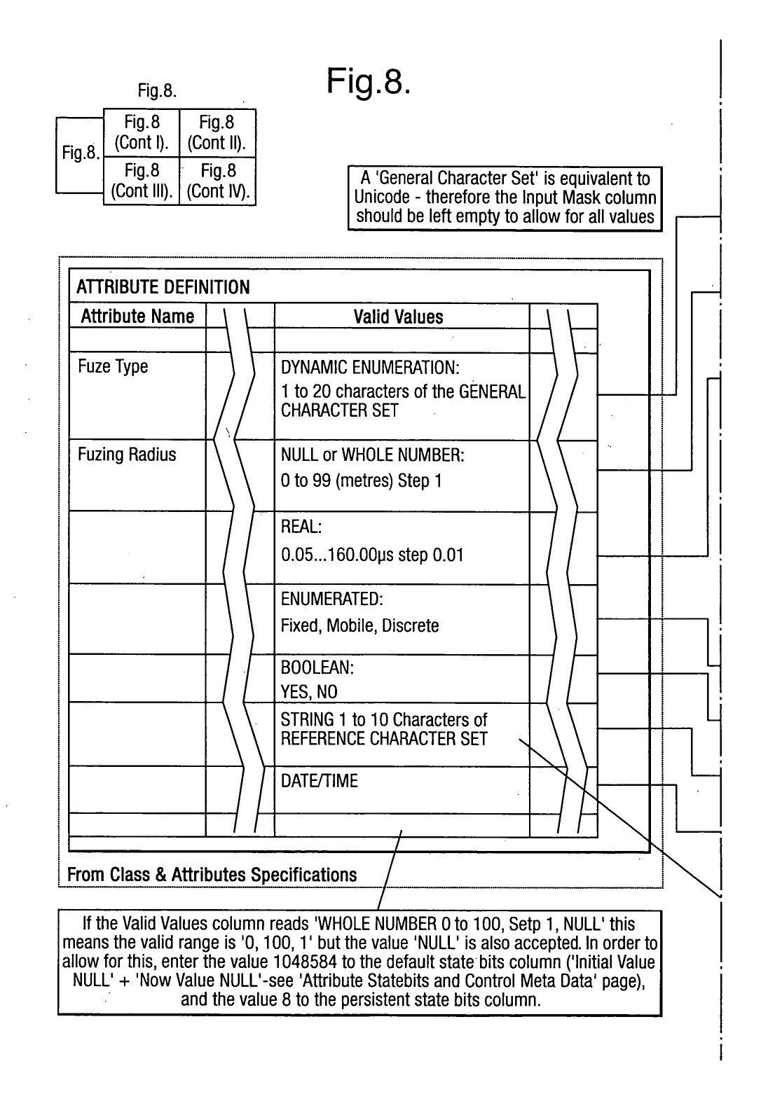

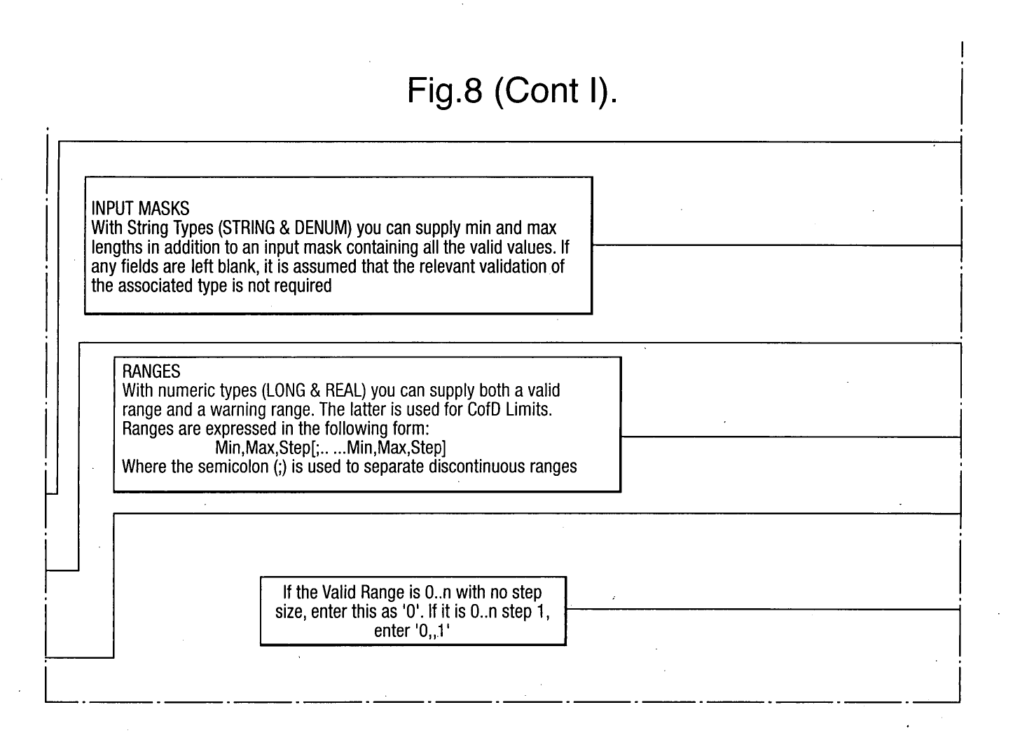

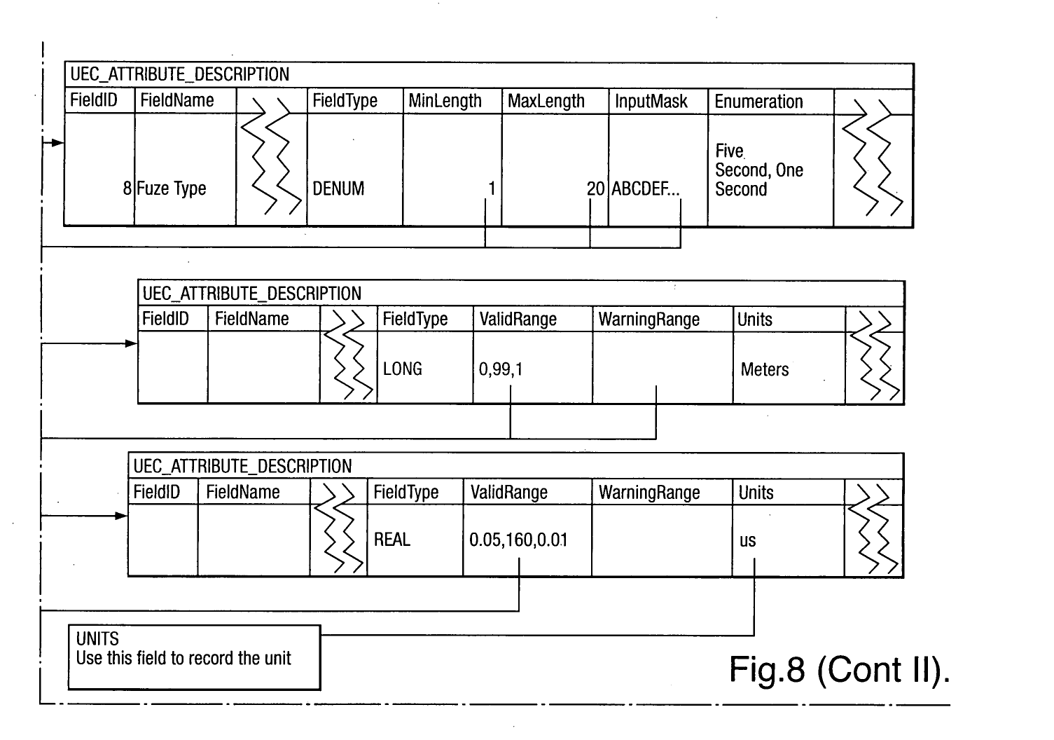

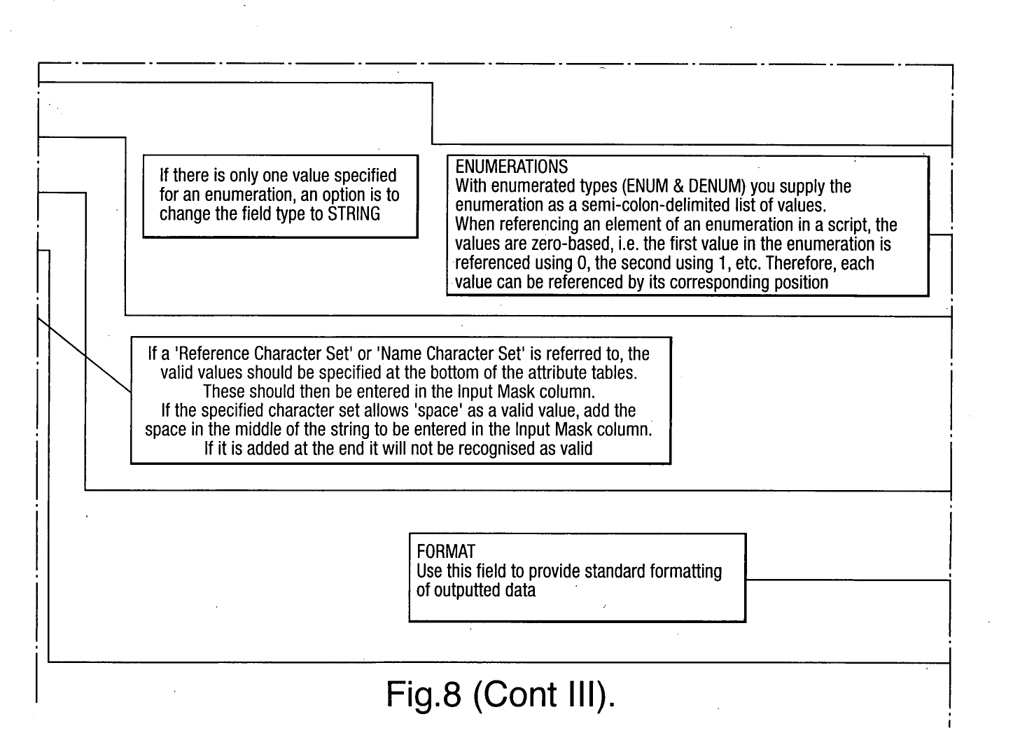

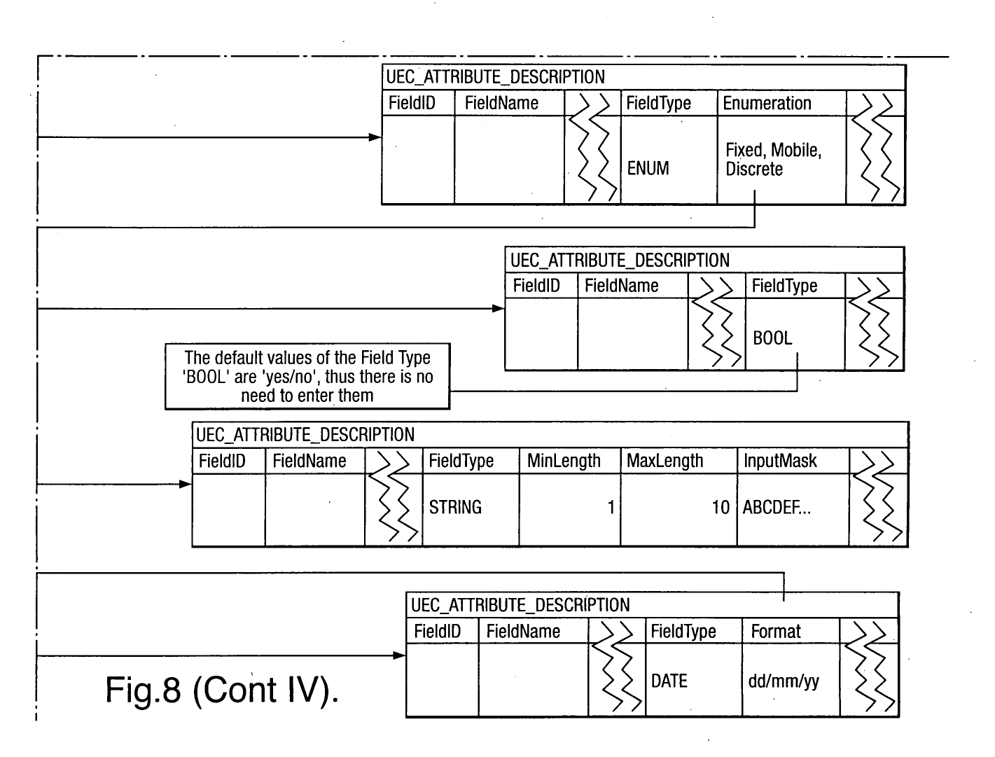

FIG. 8 illustrates Attribute Meta Data Basic Types;

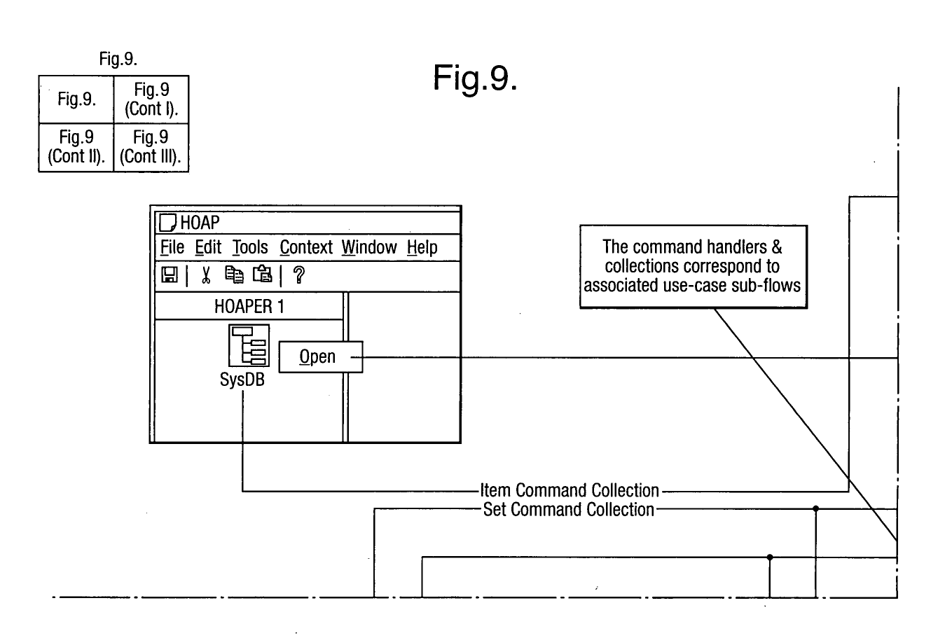

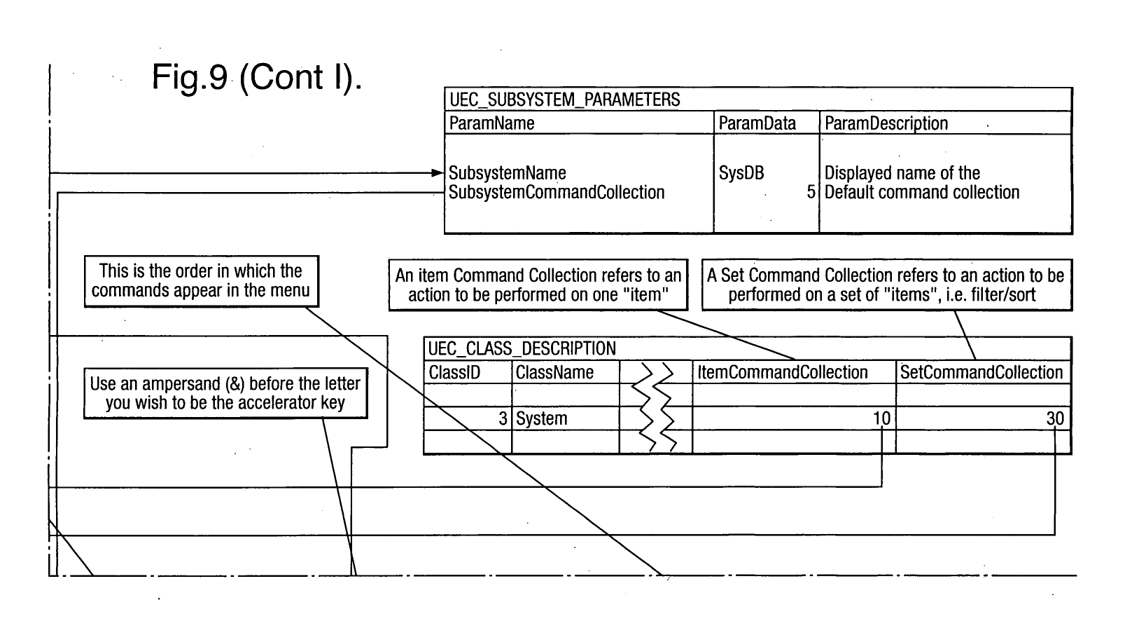

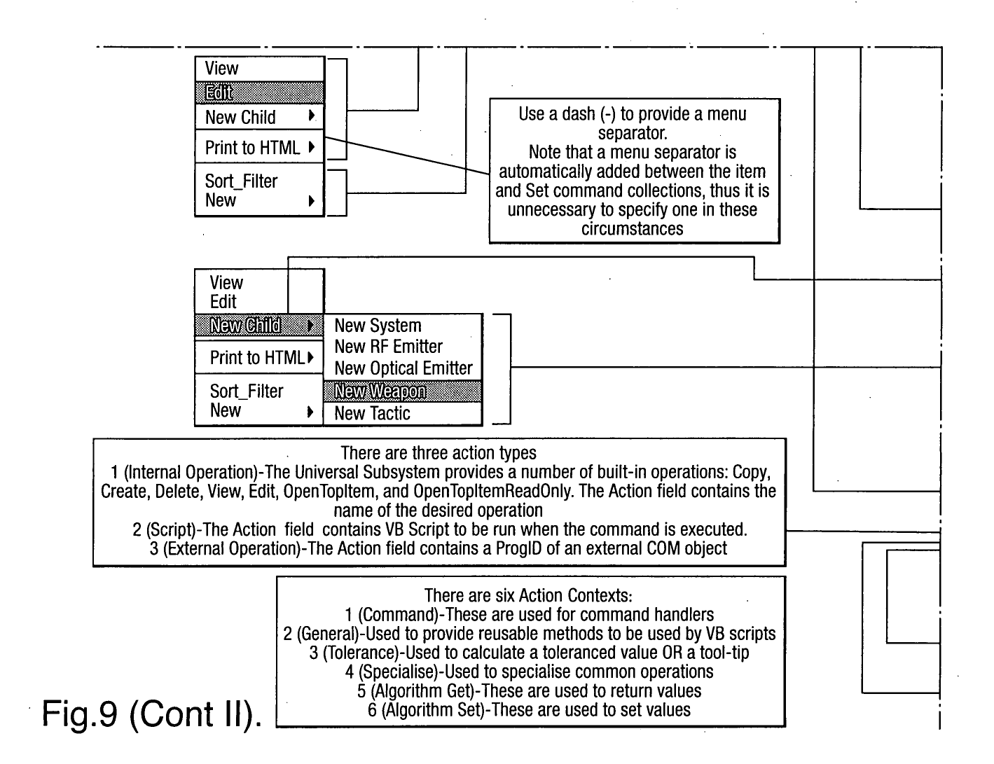

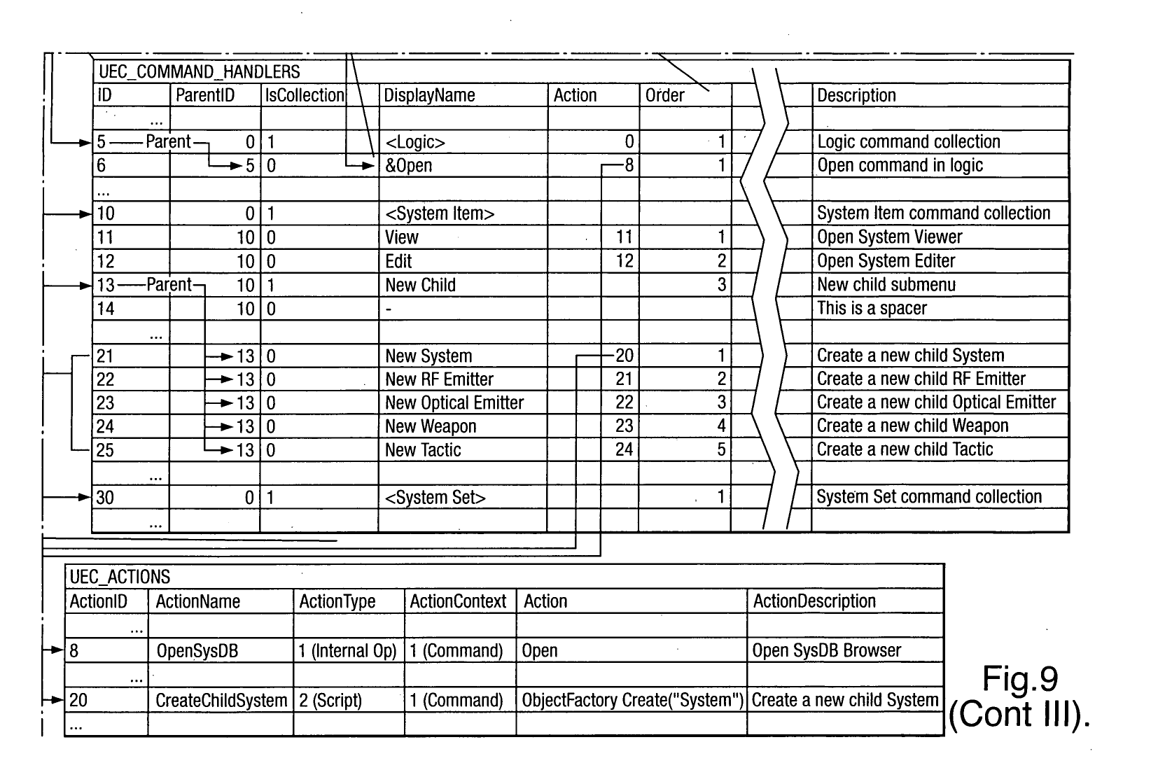

FIG. 9 illustrates Command Collections and Handlers;

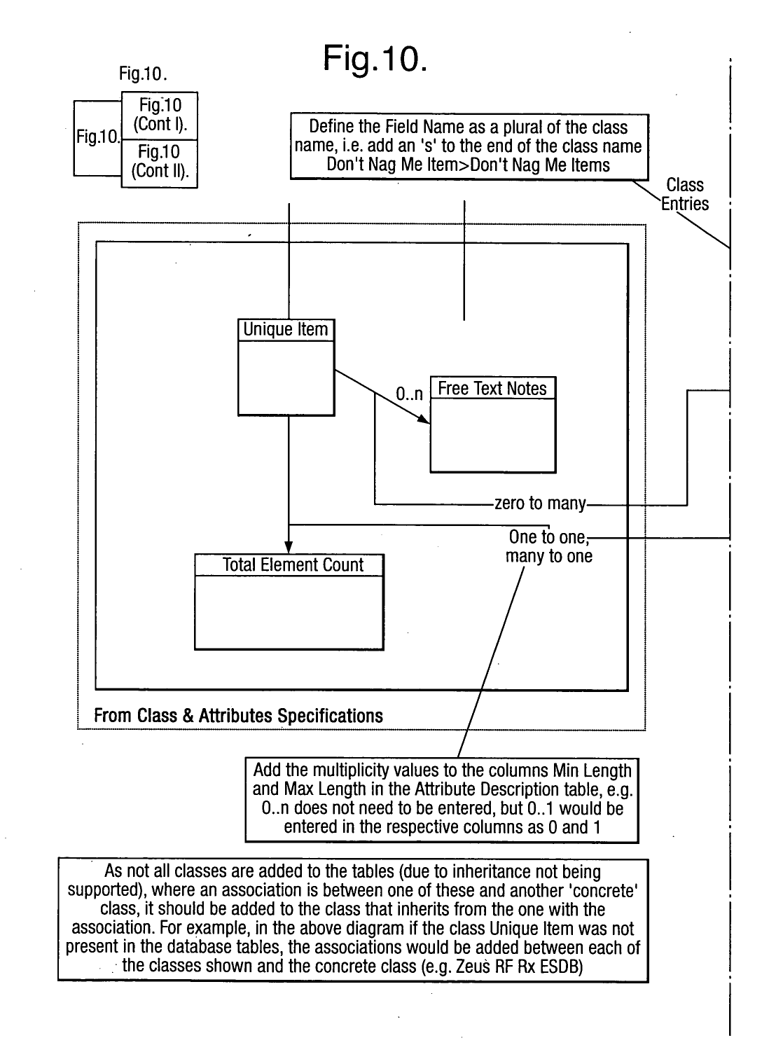

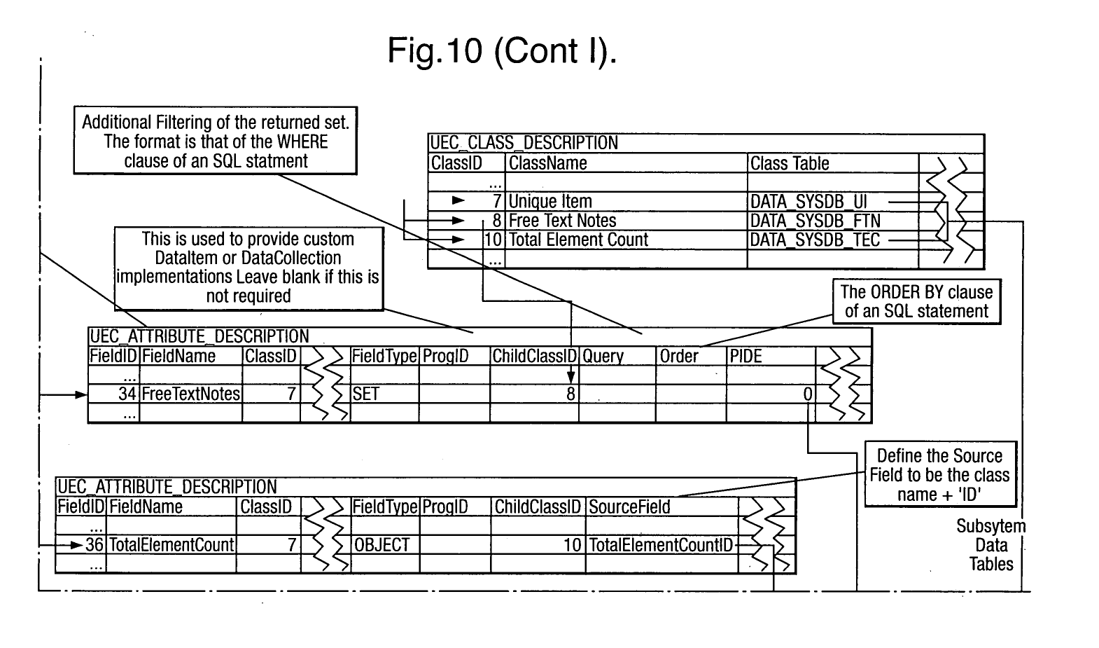

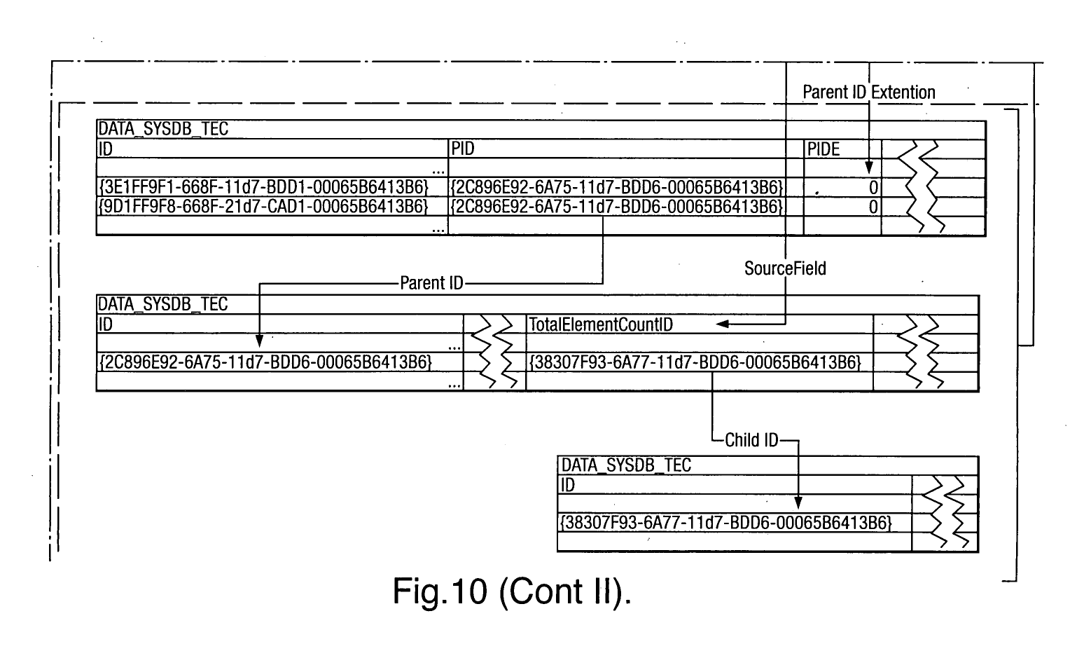

FIG. 10 illustrates Attribute Meta Data Objects and Sets;

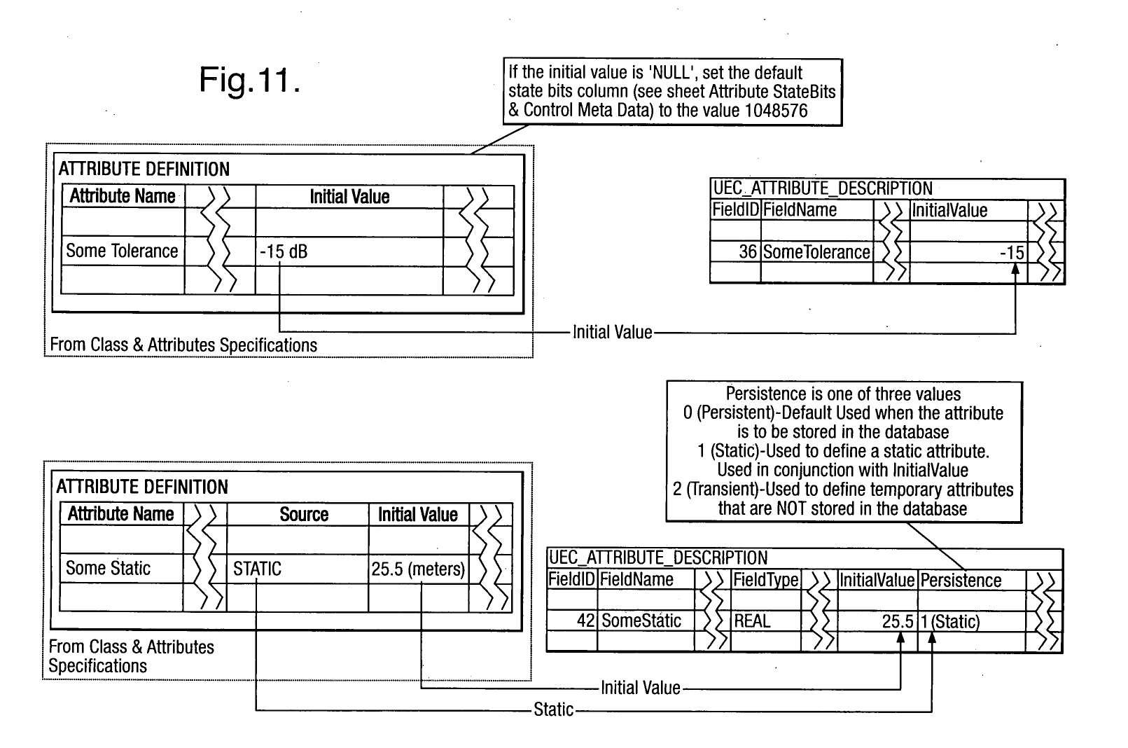

FIG. 11 illustrates Attribute Meta Data Persistence and Initial Values;

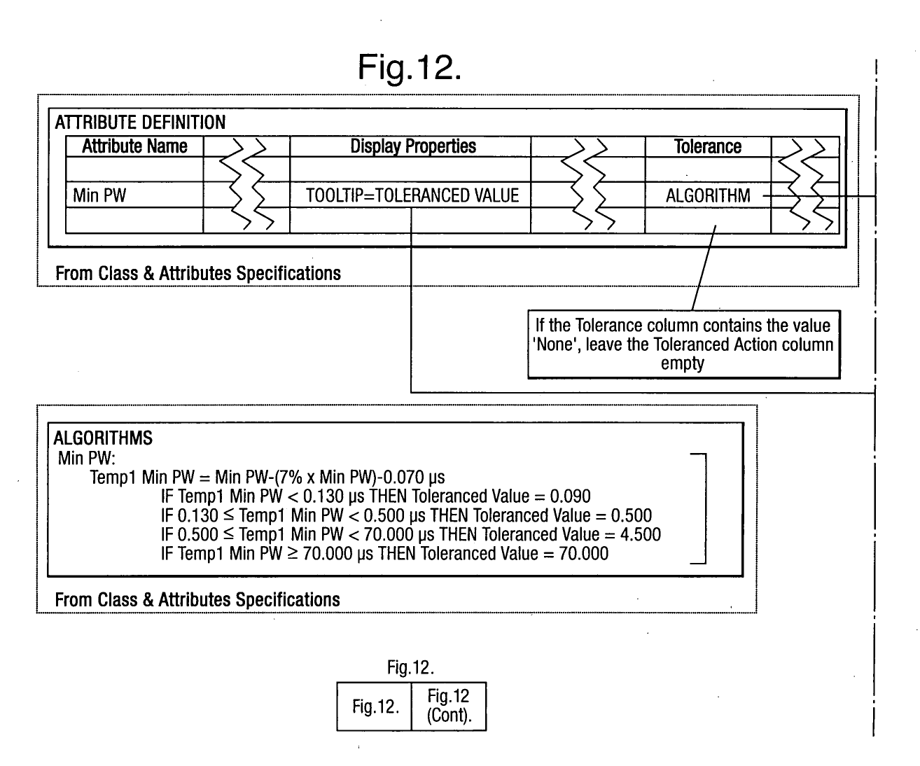

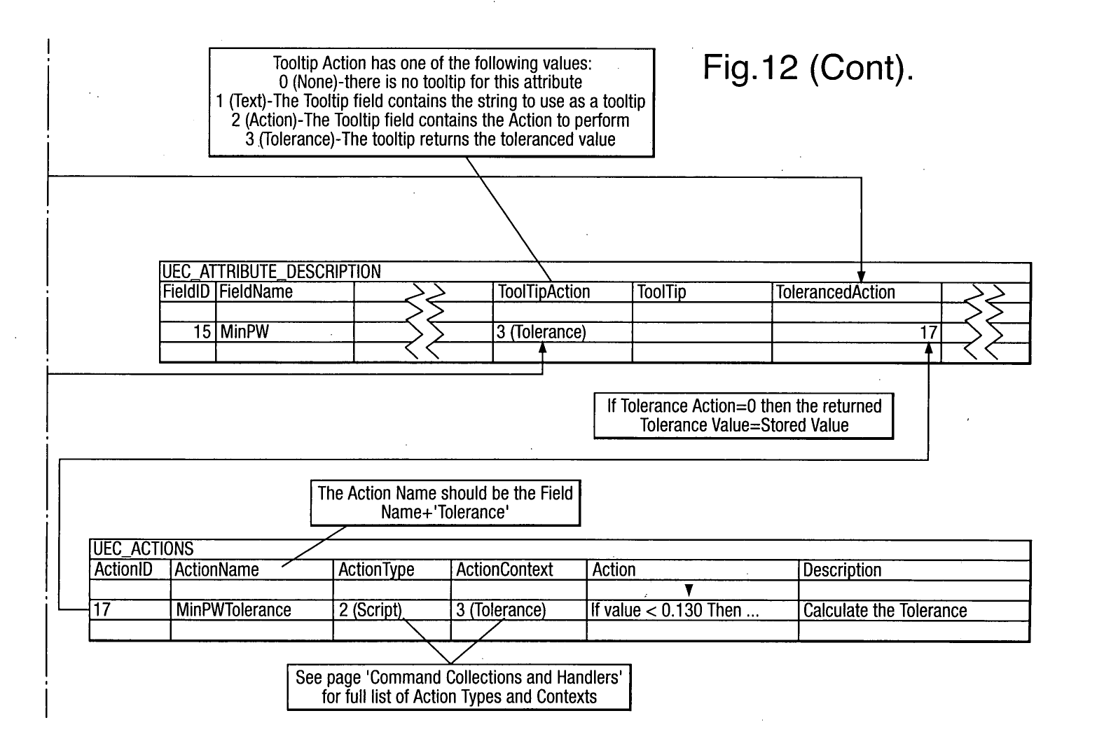

FIG. 12 illustrates Attribute Meta Data Tolerancing and Tooltips;

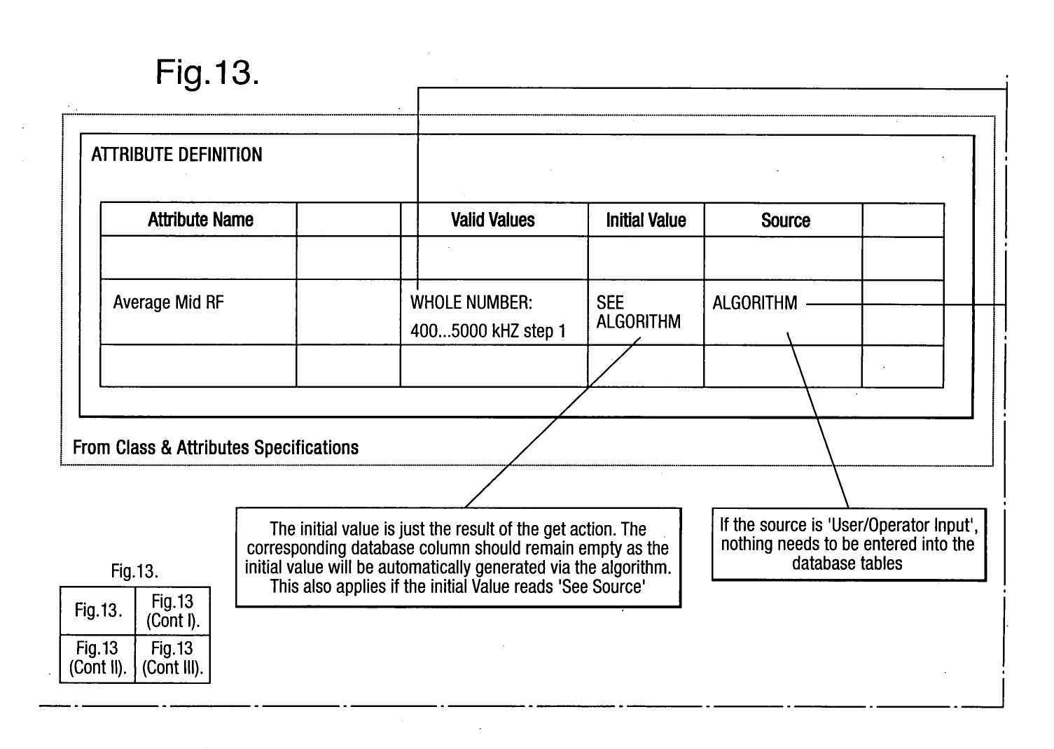

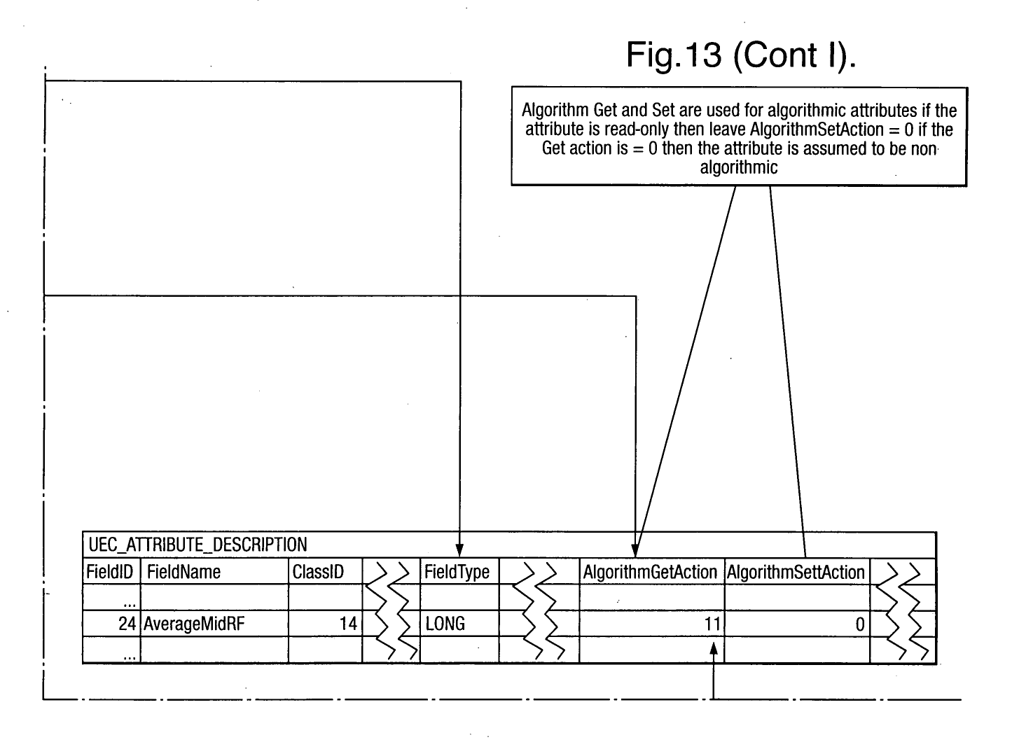

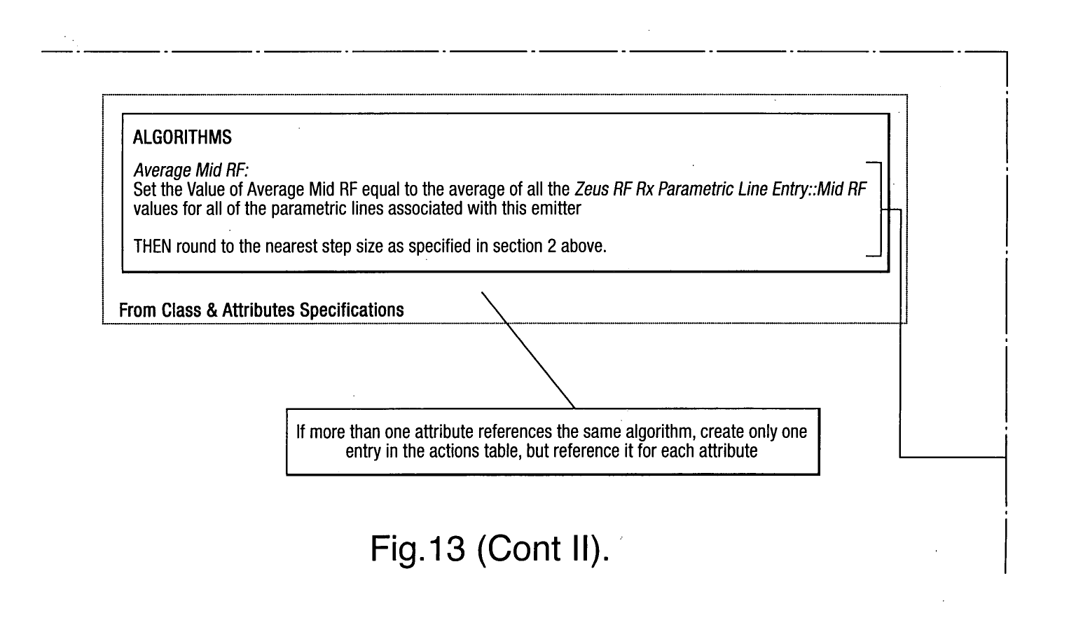

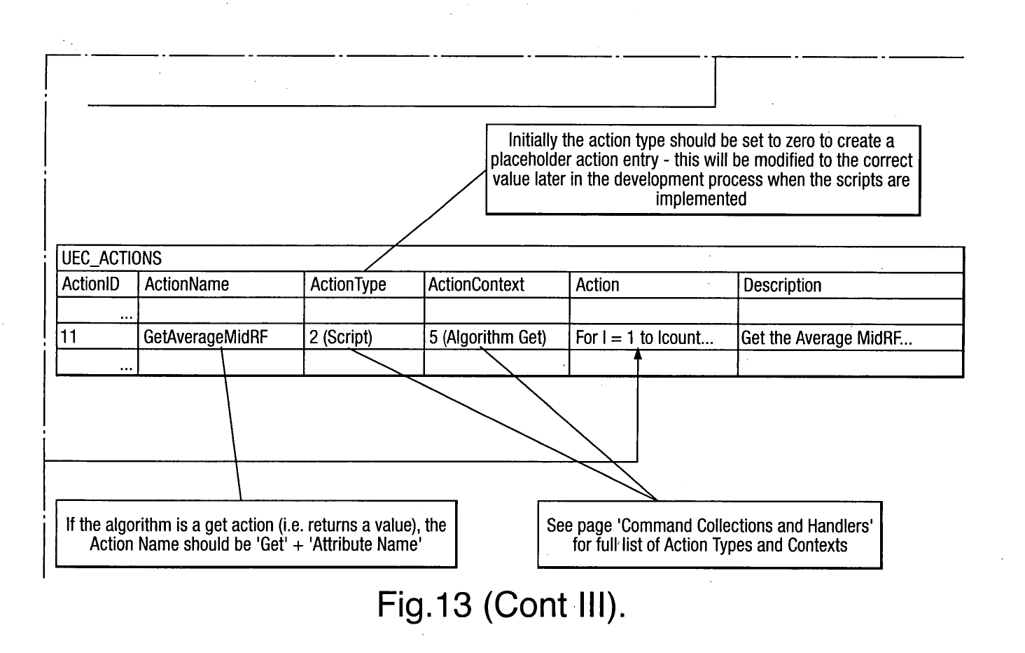

FIG. 13 illustrates Attribute Meta Data Algorithms;

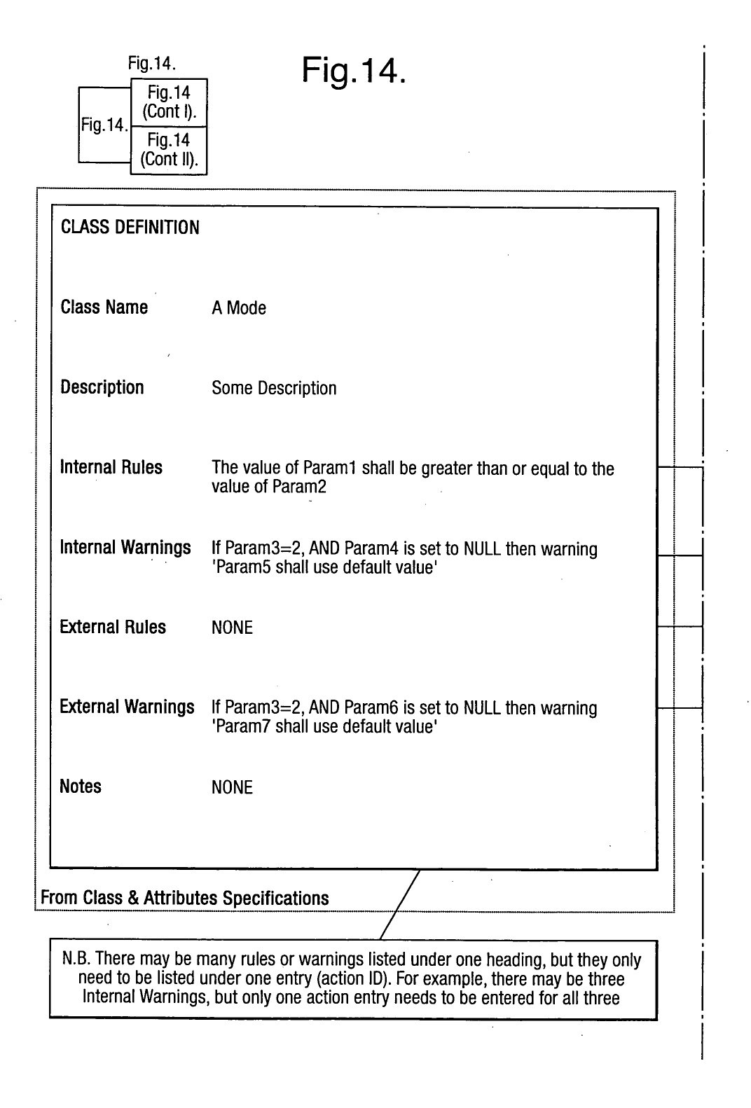

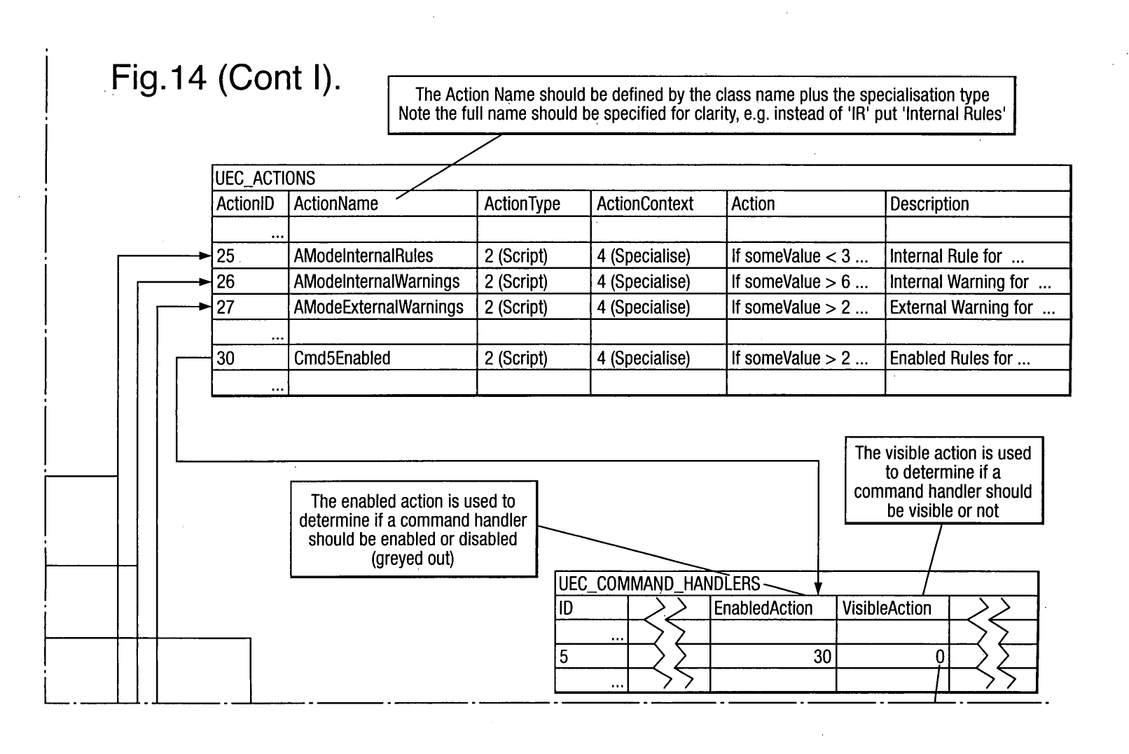

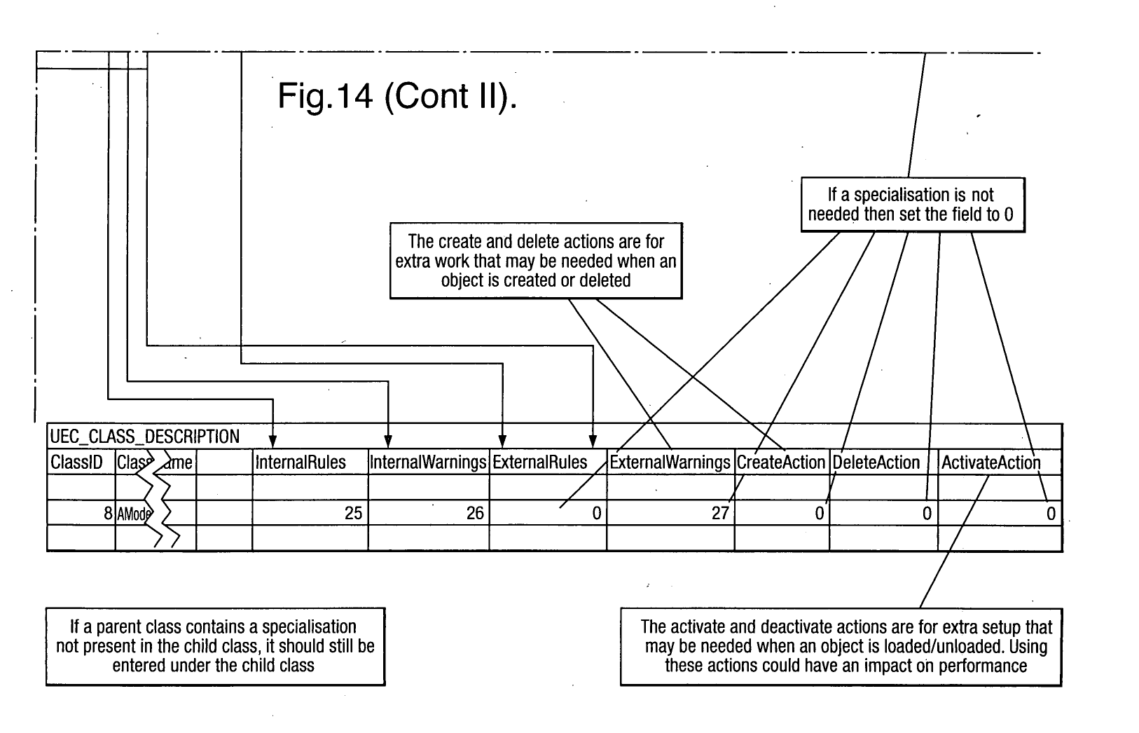

FIG. 14 illustrates Specialisations;

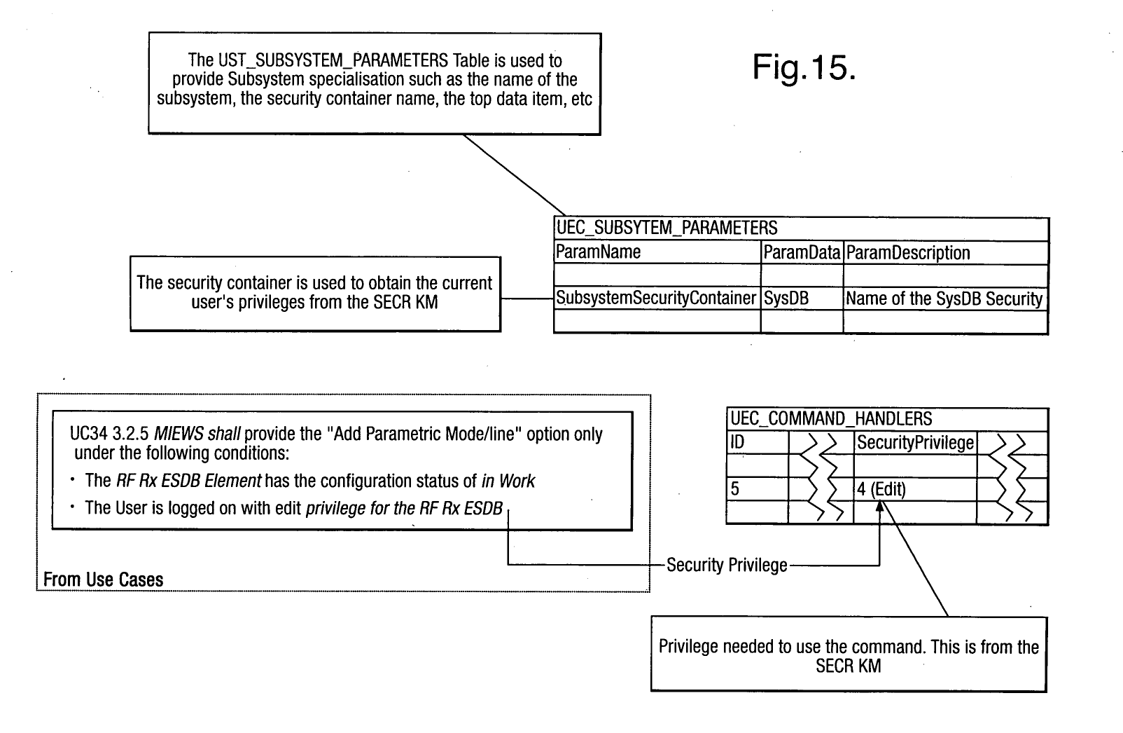

FIG. 15 illustrates Security;

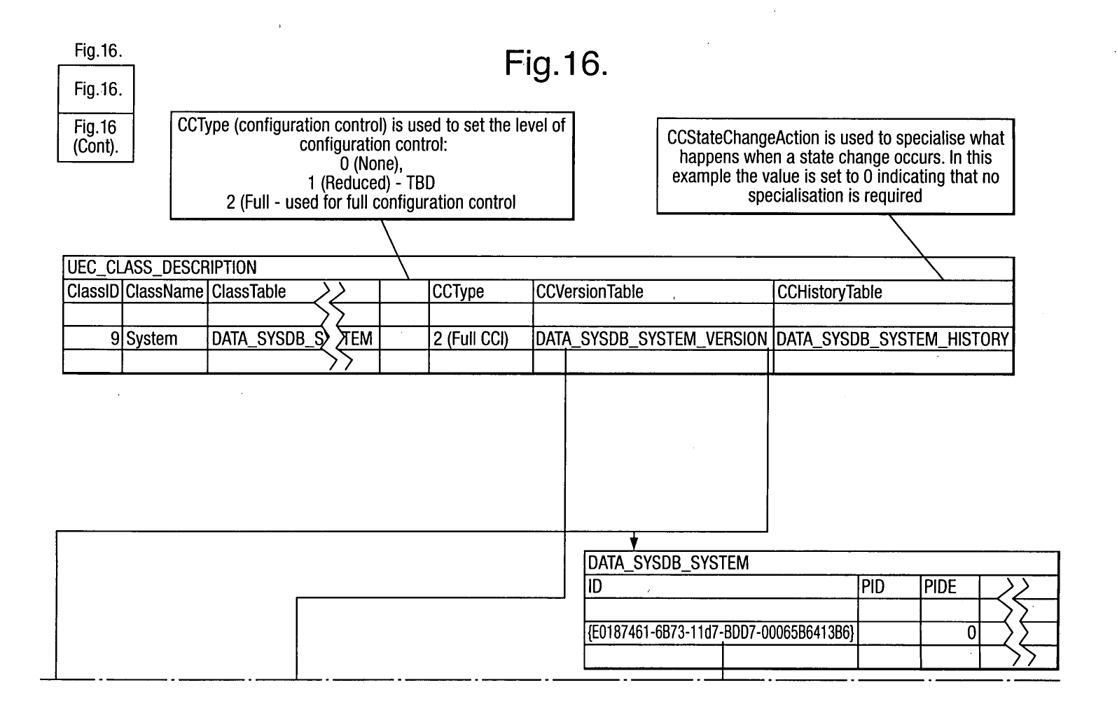

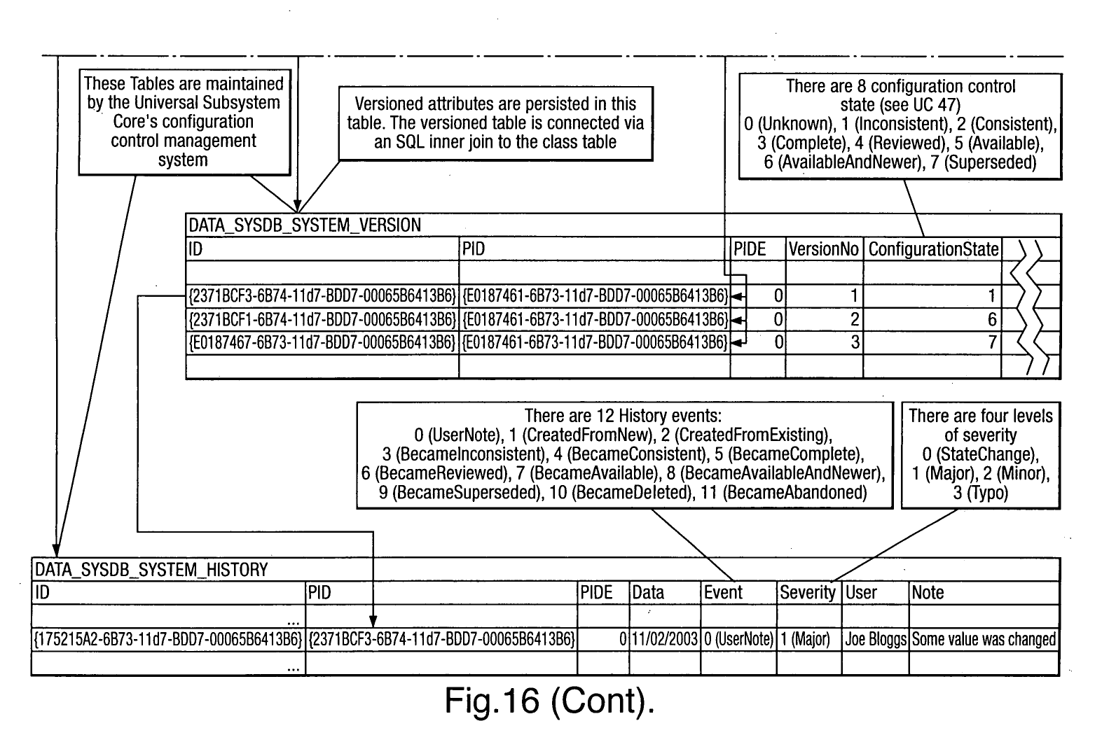

FIG. 16 illustrates Configuration Control;

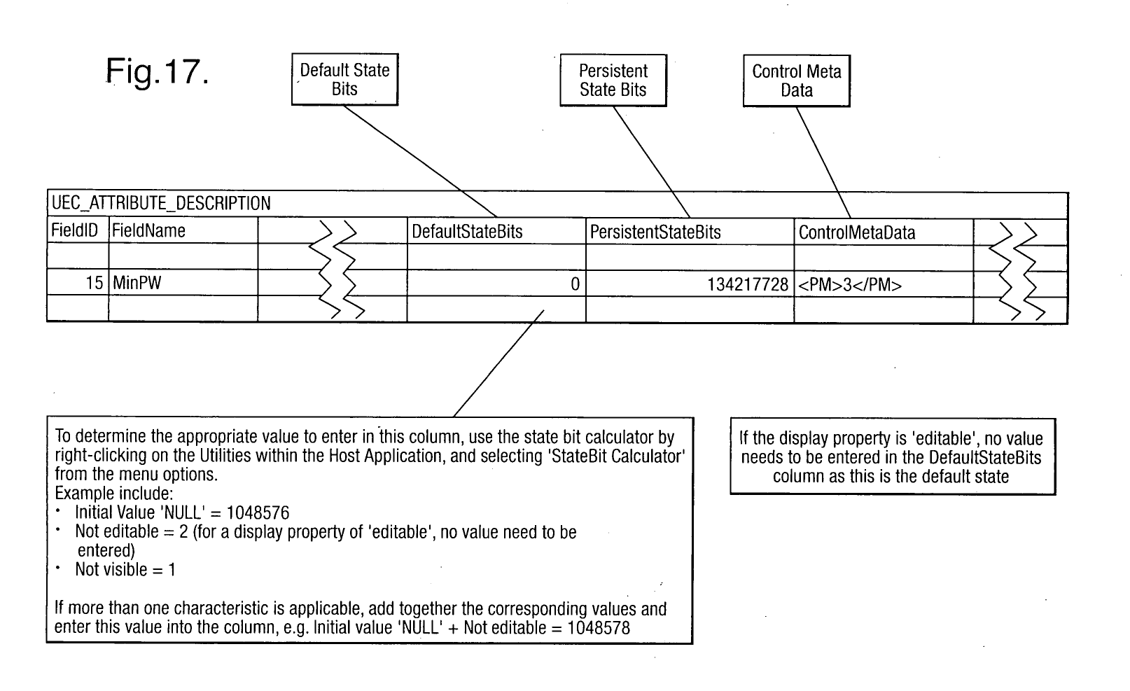

FIG. 17 illustrates Attribute State Bits and Control Meta Data;

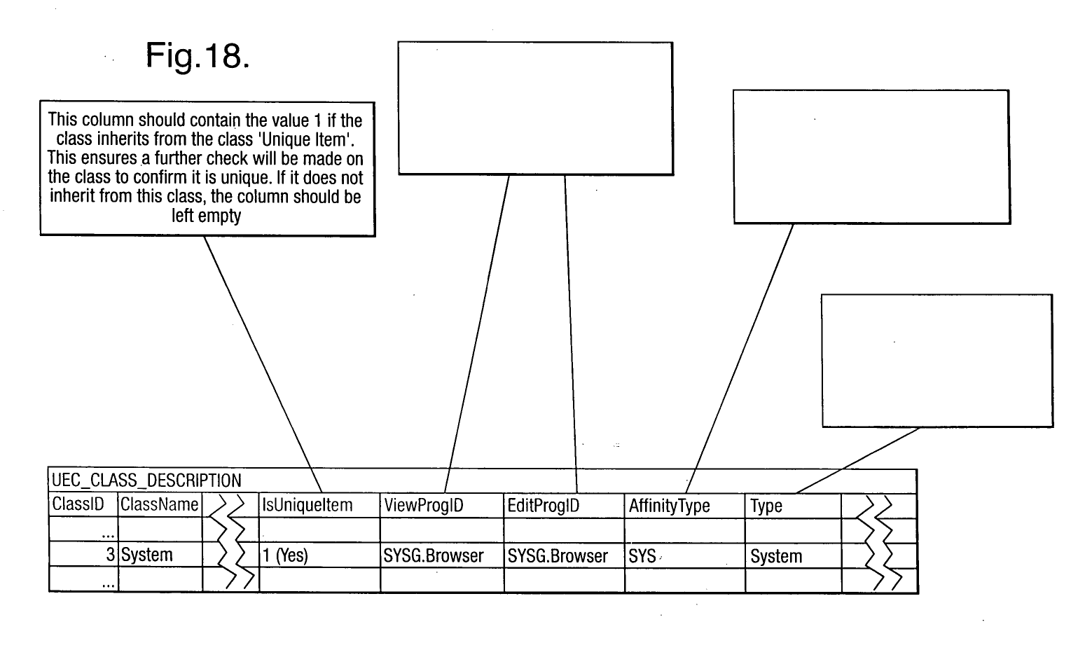

FIG. 18 illustrates Additional Class Data;

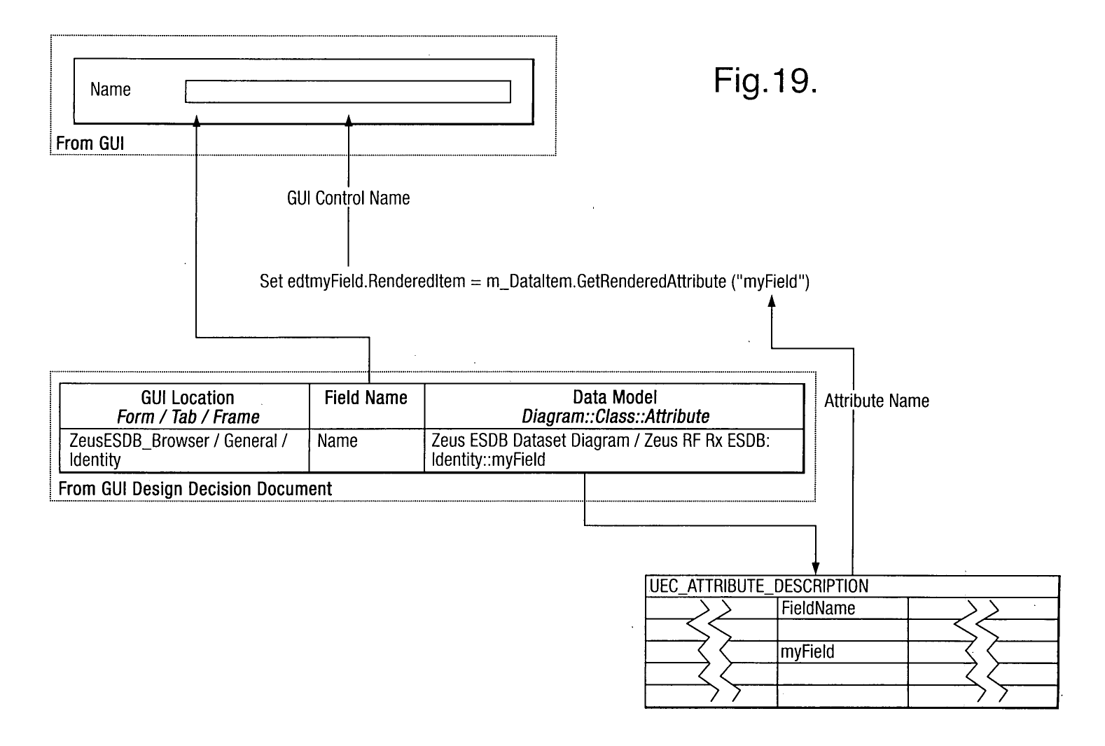

FIG. 19 illustrates an overview of mapping of GUI controls to database attributes;

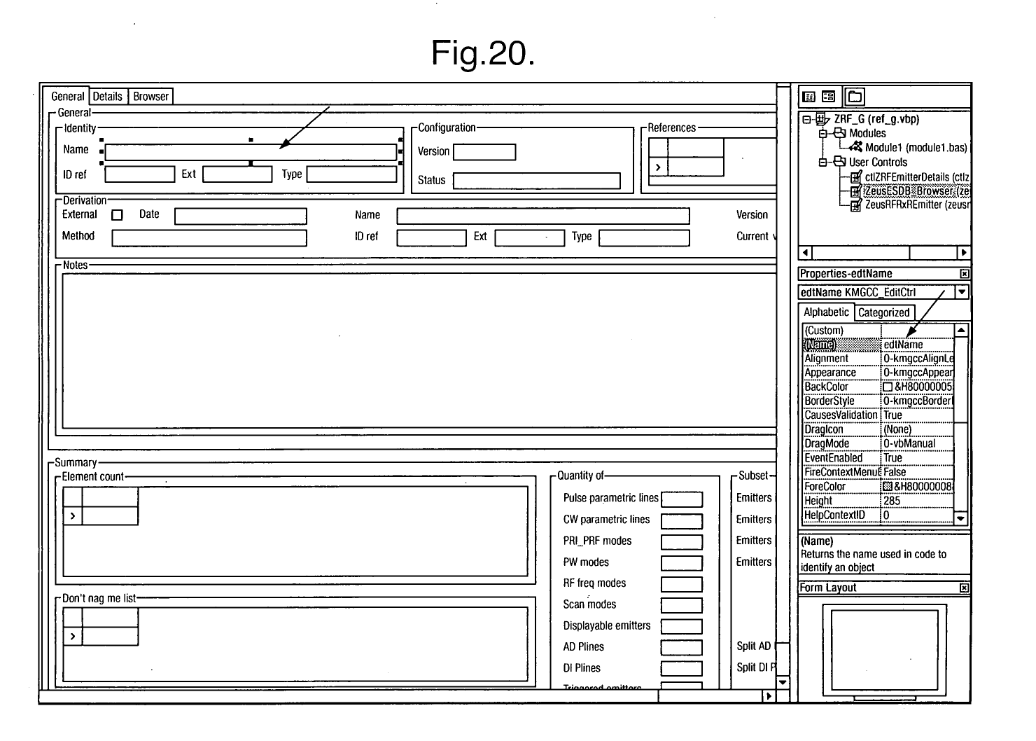

FIG. 20 illustrates an example of a GUI layout;

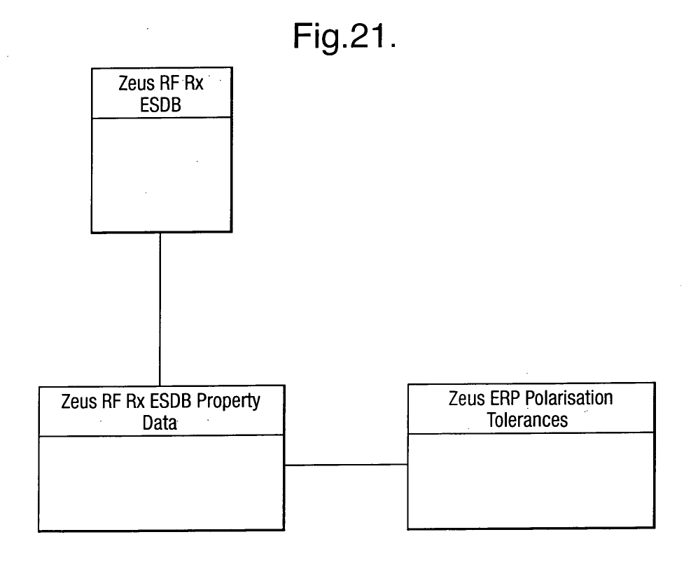

FIG. 21 illustrates object associations between classes;

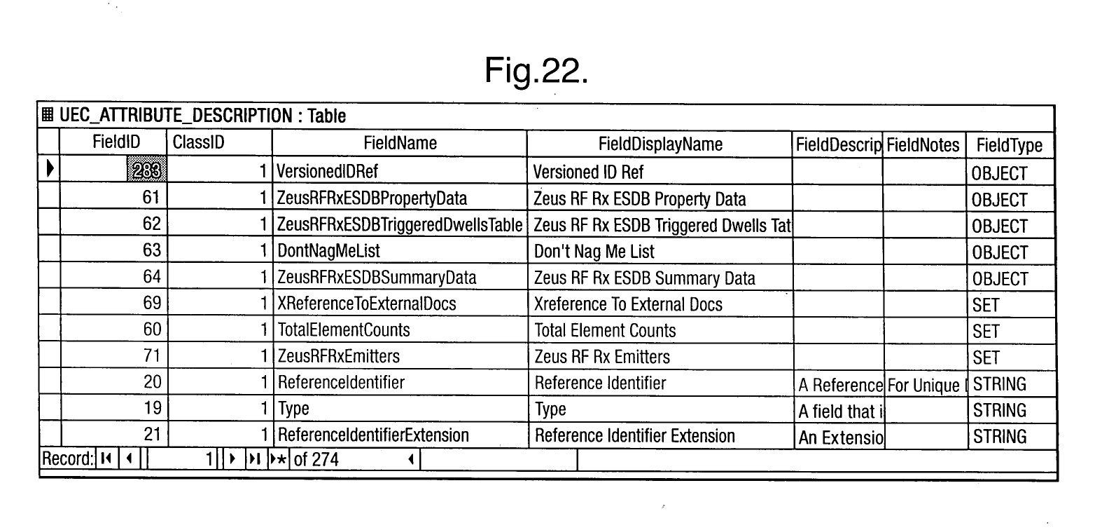

FIG. 22 illustrates an extract from database table UEC Attribute_Description;

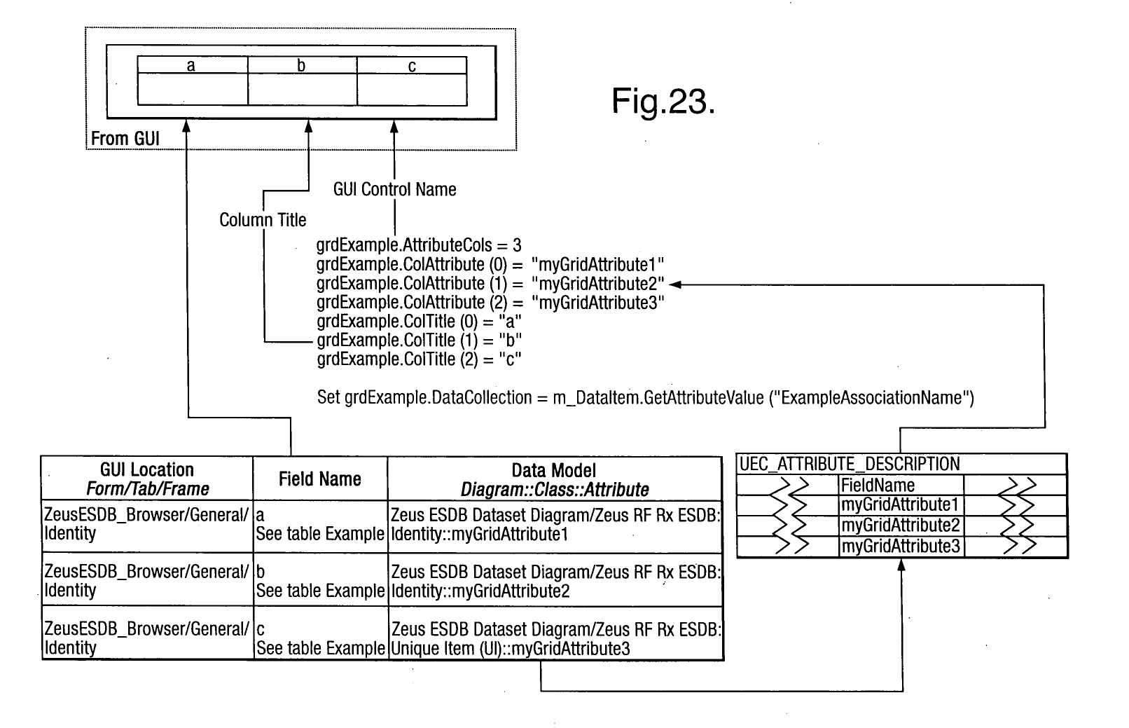

FIG. 23 illustrates an overview of mapping grid controls to database attributes;

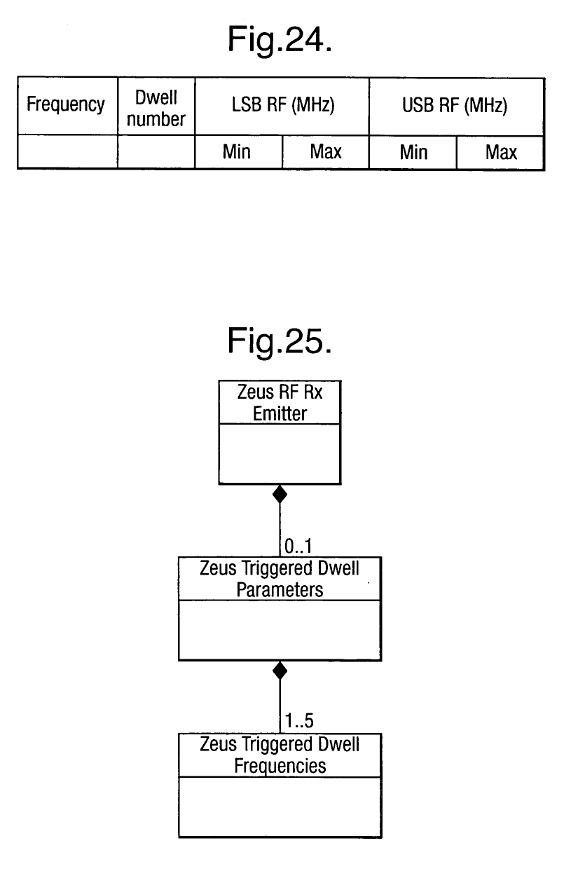

FIG. 24 illustrates an extract from ZRF GUI design decisions;

FIG. 25 illustrates set associations with a multiplicity of 0 . . . 1;

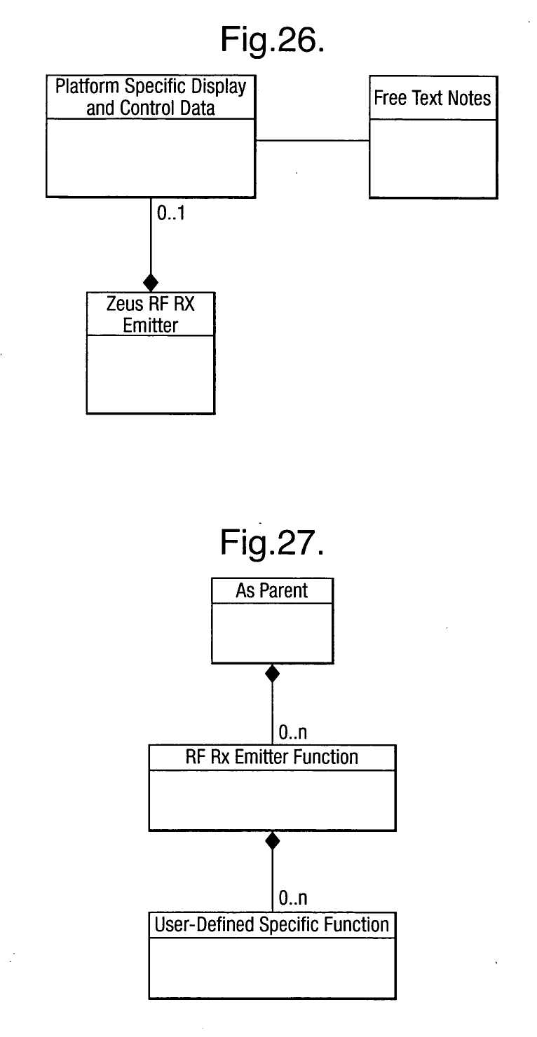

FIG. 26 illustrates object and set associations between classes; and

FIG. 27 illustrates set associations between classes.

The present invention allows for a high degree of re-use. Central to the invention is a distributed Windows®-based software-based architecture that allows rapid development and deployment of many mission-critical database-processing subsystems from a base architecture. (Windows is a registered trademark of the Microsoft Corporation.) For example, the base architecture may be a mission support system for a vehicle and the development of such a mission support system for individual vehicles can be implemented using the present invention. It will be appreciated that the mission support system for each individual vehicle will need to be interfaced with other systems in the vehicle, for example, its control system.

The invention replaces major parts of individual subsystems with a single data-driven subsystem (known as the Universal Subsystem Core (USC)) and data tables (stored in a relational database). This means that architectural dependencies can be confined to the single USC and steps in any development process have been simplified and reduced in number. Moreover, the knowledge of systems engineers can be used much more directly in creating a finished product whilst allowing existing software subsystems and software components of an original architecture to be used.

In accordance with the invention, data-driven software is applied to an existing complex component object model (COM)-based architecture in the following ways:

By using data to define the schema of an object-oriented data of an application in such a way that the architecture can be used with any relational database as well as with an object-oriented database;

By using a flexible method of using Visual Basic scripts and calls to COM objects in data tables to illustrate the correspondence between real-world entities (e.g. screen menus and user data) and the corresponding data structures within the Universal Subsystem. Due to the directness of these correspondences, systems engineers can develop software subsystems with a much reduced dependency on software expertise.

The system of the present invention has the advantage that a plurality of separate, specific applications can be interfaced with a common architecture. This greatly facilitates the rapid deployment and upgrade of functionality of the mission support system to all its users, which results in major cost savings to all concerned.

The present invention also has the advantage that productivity can be increased by a substantial amount when providing a developing a mission support system for a different vehicle.

Referring now to FIG. 1, a base architecture 100 for a mission support system is shown together with four different vehicles or platforms 112, 114, 116, 118 for which the support system is to be interfaced and developed. For example, the base architecture 100 may correspond to a general mission support system for an aircraft and the platforms 112, 114, 116, 118 relate to different types of aircraft. Whilst the mission support system is defined by the architecture 100, it needs to be interfaced with other systems on the other aircraft, platforms 112, 114, 116, 118, which are usually different due to the specific requirements of each platform.

The architecture 100 is code driven and comprises a plurality of subsystems (not shown) which carry out the function(s) of the mission support system. The architecture 100 can be represented, in different aspects, by blocks as shown in FIGS. 2 and 3.

In FIG. 2, a block 200 is shown which comprises three layers or sections 210, 220, 230. Section 210 is the core of the architecture 100 (FIG. 1) and includes all the essential requirements of the mission support system. This section interfaces with section 220, the domain of the mission support system. In section 220, all the executable applications are stored in the form of a relationship-oriented database, such as, an SQL database. Section 230 sits on top of section 220 and includes all the bespoke requirements for the particular platform 112, 114, 116, 118 (FIG. 1).

FIG. 3 illustrates a block 300 which includes layers or sections 310, 320, 330 as shown. Sections 310, 320, 330 correspond to sections 210, 220, 230 respectively of FIG. 2. In FIG. 3, section 310 has all the core data or common code for the mission support system; section 320 has the logic and operational data; and section 330 has the graphical user interface (GUI) which changes for each subsystem of the mission support system in response to input data (bespoke requirements).

The logic and operational data of section 320 includes subsystem definition tables (not shown). These tables include application-driven data and equipment-driven data: both the application-driven data and the equipment-driven data being specific to the particular aircraft which will utilise the mission support system.

In accordance with the present invention, the architecture 100 (FIG. 1) is effectively a software developer's toolkit and is based on a set of key mechanisms (KMs) and subsystems. The KMs characterise and/or realise significant and common interfaces, conventions and behaviours of the mission support system. The subsystems implement the functionality of the mission support system. This achieved by section 330 (FIG. 3) allowing data to be inserted; section 320 (FIG. 3) allowing manipulation of the data; and section 330 (FIG. 3) allowing storage of the data.

It therefore follows that a universal subsystem (USS) is generated for an integrated mission support system (IMSS). The USS essentially allows the repackaging and re-implementation of many of key mechanisms (KMs) of a previous architecture of the IMSS and hides most details about the key mechanisms from subsystem developers.

The USS is therefore a development tool which removes visibility and reduces complexity and lends itself to implementation by system engineers. The USS is also a re-usable implementation of all the core functionality.

The invention provides a reusable implementation of all the Create, Read, Update and Delete core functionality of the IMSS, and is a change to the way in which subsystems are generated.

The USS improves on the previous architecture in the following ways:

It makes a significant reduction in the volume of code to be generated, and a corresponding reduction in the effort required for testing.

It provides for rapid (and truly iterative) subsystem development.

It achieves a much closer correspondence between the problem (e.g. Class & Attribute specifications) and the design/code, resulting in a design that is easier to understand and to maintain.

It reduces the extent of coding skills required, with a more direct use of the knowledge of systems people. This reduces the need for teams with different disciplines, and hence the overheads of managing such teams.

It provides the ability to automatically check and/or enforce the integrity of the design of a subsystem, since the design of the subsystem design is now substantially reflected in data tables.

It removes dependence on the database vendor. Initially an SQL server is used, but in principle any relational database of adequate performance could be adopted. A future change of database will now only affect the “Universal Subsystem”.

The USS achieves its purpose by changing the way in which the Entity, Logic and GUI components of subsystems are constructed. The method of constructing a subsystem using the USS is described below.

The USS allows a subsystem to be constructed from the following items:

The USS itself (this will be described in more detail below).

One or more ActiveX GUIs.

Data tables (stored in a relational database), which characterise the behaviour and data of the subsystem. These comprise:
Subsystem Definition Tables which have the same form for each subsystem. They specify the nature of the actual data to be stored with each subsystem, and they also contain and/or point to action components that are to be executed in conjunction with this data (e.g. command handlers, consistency checkers).
Subsystem Data (Class) Tables which are created by a USS utility after the Subsystem Definition Tables have been populated, as described in more detail below. These tables comprise the actual data stored by each subsystem, the schema for which is essentially established by the subsystem Definition Tables.

A set of scripts and other algorithmic components (collectively referred to below as action components) which are called as defined by the data tables. Some of these are provided as standard facilities of the USS itself.

The nature of the GUI components, data tables and action components, and the process for constructing subsystems using them, is described in more detail below.

A subsystem can thus be viewed as an extension to the USS comprising GUI(s), action components and tables. This is illustrated in FIG. 4.

Each subsystem provides a relational database and a run time instance of the core reads the subsystem definition tables from these databases and adapts itself accordingly.

In accordance with the present invention, the requirements and aims for the USS are such that there should be minimum change from previous architecture. The USS shall satisfy the same requirements and design aims as the previous architecture, for example, the requirements relating to performance, availability, reliability, modifiability, portability, reusability, testability, projected life span of the system and rollout schedule should be substantially the same. The use of the USS shall not require any changes to the interfaces provided by key mechanisms (KMs) in the previous architecture, unless specially justified. The USS shall provide equivalent functionality for all KMs in the previous architecture unless they are no longer required.

KMs characterise and/or realise significant and common interfaces, conventions and behaviours of the system, for example, all external interfaces and interactions of subsystems.

Three groups are derived which correspond to system requirements, decisions about the architecture and decisions about the technology to be used respectively. For example, the system requirements include the relationship of database subsets; the decisions about the architecture include the method by which subsystems and the host application interact; and the decisions about the technology to be used include the particular database technology.

The USS hides and/or simplifies the interfaces to the KMs and minimises the extent to which subsystem developers need direct knowledge of the KMs. Most KMs are now either private (that is, hidden from subsystem developers by the USS) or else are public (visible outside the USS) only in a very limited way. FIG. 5 indicates who the public users of the KMs now are.

The private KMs include: security runtime which applies privileges to users; reporting which associates XSL style sheets with reports; configuration control which implements the configuration control state machine, maintains version control and change histories, and mediates consistency checking; affinity which mediates ‘copy/paste’, ‘drag/drop’ and all inter-item associations; moniker which maintains all inter-item relationships, allows for ‘soft’ relationships, and supports passing of command handlers where items are references; persistent data locking which includes ‘normal’ database element locking and MDS locking of all contained subset databases; MDS subset which maintains subset databases within an MDS; subsystem which allows the pattern for all systems to be recognised by the host application etc., external interchange which supports import and export of databases for deployed operations; XML input/output allowing database data to be output in DML format so that the data can be used by reports and in inter-database data exchange; an docking and linking in which the client side allows database elements to be shown as child elements in the system tree.

The public KM interfaces are visible and may be used by system developers if required. These public KMs include: generic GUI controls which are set up on GUI forms, where little or no subsystem developer input required, and implement standard behaviour, for example, colour codes for warnings etc., entity which maintains the databases and elements and supplies common interfaces for the mission support system; sort and filter which presents standard GUIs for sorting and filtering data, discovers the sortable/filterable fields from the entity, and stores user filters; event interfaces which allow components in one subsystem to listen for events generated by another component; even reporting which supports de-bugging; platform specific data which allows platform specialisation of common databases; database manager which acts as a common manager for all database connections and transactions on the client; and command pattern which is used whenever a GUI component dynamically displays a set of operations provided by another loosely coupled component, and is visible in the subsystem as data driven actions or command names, for example, common commands implemented by the architecture.

There are also KMs in the host application. These include: INST which allows user to set up data such as application name and system security classification; host application new window which allows subsystems to open new windows within the host application; start-up which finds the registered subsystems so that they can be displayed in the host application navigation view; and wrap executable which allows bespoke implementation of specific interfaces to the mission support system.

The USS maximises reuse across subsystems of data and functionality associated with Core and Domain layers of specialisation in IMSS. The fields associated with classes in the subsystem definition tables may be annotated to indicate whether the field relates “Core”, a particular “Domain”, or “Concrete”. This is useful information and allows some additional enforcement of design rules within the data tables, e.g. inheritance.

Ideally, the USS has independence from database vendor and is designed accordingly.

The USS has ease of maintenance and reuse. When a new version of the universal subsystem core (USC) is produced, and/or when an update to the schema of the subsystem definition tables is made, there should be no impact on nor a need to rebuild any subsystems previously developed using the USS. Moreover, the names and structures of the subsystem definition tables reflect as accurately as possible the names and structures of the problem domain to which they correspond, and this correspondence itself is to be clearly described with examples wherever possible.

The programming language used is be maintainable. For example, the USC could be written in Visual Basic for ease of maintenance, except where a justification for another language is made on the grounds of performance or functionality.

Informal performance and memory leak tests can be taken after each new facility is added to the USC. Any significant changes in performance or memory leaks associated with the use of a code construct can then be documented in a “performance record” for future reference.

FIG. 2 illustrates the components which make up the USS. The central engine of the USS is the USC which comprises various Classes, Modules and Forms. The Classes are all Component Object Model (COM) objects and are listed in Table 1.

TABLE 1

| 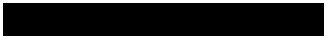 | 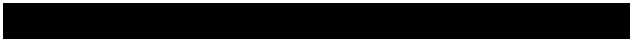 |
|---|---|
| USC_Action | Stores information about actions—this class contains no |
| | methods. |
| USC_Actions | Handles all the interactions with the three types of |
| | actions—Internal, external and script. |
| 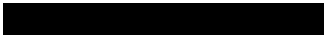 | 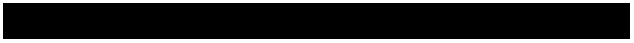 |
| 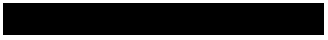 | 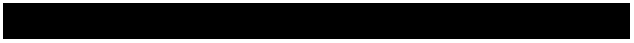 |
| USC_Command | This class is a command handler. |
| USC_CommandCollection | Implements the command collections. |
| 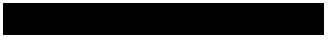 | 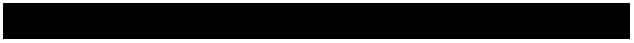 |
| USC_DataEvent | This class is an event object sent to event sinks. |
| 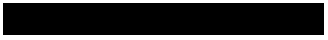 | 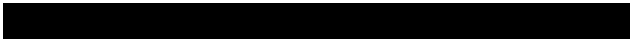 |
| 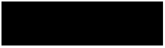 | 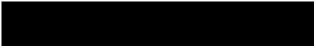 |
| USC_EventManager | This class distiibutes the received events to the |
| | transactions and sends events to the Winsock form. |
| USC_FTDataCollection | Implements KMENT.IKMENT_DataCollection |
| USC_FTDataltem | Implements KMENT.IKMENT_DataItem2 |
| | Implements KMENT.IKMENT_DataItem |
| USC_InternalAction_Copy | Provides a common Copy implementation. |
| USC_InternalAction_Create | Provides a common Create implementation. |
| USC_InternalAction_Default | Provides a default action in order to prevent crashes if no |
| | action is specified. |
| USC_InternalAction_Delete | Provides a common Delete implementation. |
| USC_InternalAction_Edit | Provides a common Editor Launch implementation |
| USC_InternalAction_EditTopItem | Provides a common Edit For Top Items implementation. |
| USC_InternalAction_View | Provides a common View implementation. |
| USC_InternalAction_ViewTopItem | Provides a common View Top Item implementation. |
| USC_Manager | This is used to create entities in such a way as to prevent |
| | duplicates being formed. |
| USC_NotifyInfo | This class is a database event object sent to event sinks. |
| USC_ObjectFactory | This class is used to create, delete and copy objects. |
| USC_RegisteredObject | This class is a holder for information on registered |
| | objects. |
| USC_Renderer | This class provides a generic renderer for GUI controls |
| USC_ScriptObject | This class exposes the DOM to scripts |
| 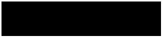 | 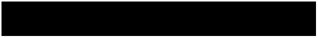 |
| USC_TransientRenderer | This class is used to provide non database rendering. |
| | This class is never seen by a subsystem. |

The shaded entries are useful starting points when understanding and navigating the design.

The Forms of the USC are given in Table 2.

TABLE 2

| Name | Purpose |
|---|---|
| USC_UniqueItemGUI | A modal dialogue box that is opened when the |
| | user wants to create a Unique Item. |
| USC_Winsock | This form holds the two Winsock controls to |
| | communicate with the event server. |
| | WskConnection is used to establish a connection |
| | with the server on a known port |
| | The server then sends wskConnection the |
| | dedicated port number which is used to connect |
| | wskClient. |
| | WskClient is used to send and receive events |
| | from the server. |

The Module used is USC_Global which holds global variables and common types of functions. It could be considered to be several cohesive modules operating together.

The KM interfaces used with the USS are listed in Table 3. Here, the USC will provide its own implementation of some of the KM interfaces.

TABLE 3

| KM_{—} | Name | Group |
|---|---|---|
| AFF | Affinity | Docking & Linking/MDS KMs |
| ANA | Ambiguity Analysis | Other KMs |
| CCI | Configuration Control | Core KMs |
| CMD | Command Pattern | Host Application KMs |
| DBM | Database Manager | Core KMs |
| DLK | Docking and Linking | Docking & Linking/MDS KMs |
| ENT | Entity | Foundation KMs |
| EVIF | Event Interfaces | Foundation KMs |
| EVRH | Event Reporting | Other KMs |
| GCC | Generic GUI Controls | GUI Controls |
| (X) | | |
| INST | Installation and Registration | Host Application KMs |
| MKR | Moniker | Docking & Linking/MDS KMs |
| NWIN | Host Application New | Host Application KMs |
| | Window | |
| PEV | Persistent Data Events | Foundation KMs |
| PLK | Persistent Data Locking | Core KMs |
| PSS | Platform Specific Data | Core KMs |
| REP | Reporting | Reporting |
| SECR | Security Runtime | Host Application KMs |
| SST | MDS Subset | Docking & Linking/MDS KMs |
| STFL | Sort & Filter | Core KMs |
| STUP | Start-up | Host Application KMs |
| SUB | Subsystem | Host Application KMs |
| WEX | Wrap Executable | Other KMs |
| XIC | External Interchange | Reporting |
| XIO | XML Input/Output | Reporting |

The public KMs with interfaces implemented by USC are described in more detail below:

KM_CMD (used only by the HOAP, not used by USC, USC implements interfaces): this KM is used to encapsulate a request as an object, thereby allowing clients to issue requests without knowing anything about the operation being requested or the receiver of a request. This KM is used by Host Application to discover and display the operations provided by a Subsystem (among other things). This KM is used whenever a GUI component dynamically displays a set of operations where those operations are provided by another loosely coupled component. The USC implements the interfaces of this KM in the following classes:
USC_Command
USC_CommandCollection
   KM_DBM (used only by the HOAP, not used by USC, USC implements stub for interface): this KM provides a common manager for all database connections and transactions on the client, and is responsible for invoking any database functions and holding any database resources that are entity component independent and should be centrally maintained. Its responsibilities are twofold, one time initialisation and de-initialisation, and providing services for the Entity/Data components. With the USS, this functionality is no longer required. However for possible future portability to databases other than SQL Server, a stubbed version of the implementation of the interface has been kept. This interface may be used in future to initialise the database.
   KM_ENT (used by algorithm code and by GUI hookup code, USC implements interfaces): this KM specifies the interfaces to be implemented by all Entity components so that they provide common behaviour to the GUI controls and other subsystems. The data model (collections, transactions, data items, rendered items and entity object) is entered into the subsystem definition tables as part of a subsystem's USSE (Universal Subsystem Extension). However the subsystem code for algorithms and GUI hookup needs to manipulate this data. The interfaces that allow this to happen are the interfaces from the original KM_ENT, unchanged. The implementation of these interfaces is provided in the USC in the following USC classes:
USC_Entity
USC_Transaction
USC_DataItem
USC_DataCollection
USC_Renderer.
   KM_EVIF (used only by GUI controller, USC implements interface): this KM allows one subsystem component to listen for (database) events generated by another. The GUI Controller uses this KM, since this KM is the mechanism by which KM_PEV notifies events. The subsystem developer only gets involved to the extent that he/she has to create an instance of the GUI Controller. It is intended that the GUI Controller will be brought into the USC at some stage, so the KM will then become totally invisible to subsystem developers. The implementation of the KMEVIF_Source interface of this KM is provided by KM_PEV's implementation in the old architecture, but is provided in the USC (in VB) in the following USC classes:
USC_Transaction
USC_EventManager
USC_Winsock
USC_RegisteredObject
USC_NotifyInfo (just hold data)
USC_DataEvent (just hold data)
   KM_PEV (used only by GUI controller, interface implemented by USC): this KM specifies how database events are managed within the persistent object wrapper. KM_PEV and KM_EVIF work together for a common purpose. KM_EVIF provides the raw communication mechanism used between an event source and any number of corresponding event sinks, whereas KM_PEV provides the definition of the actual events—it used to also provide the means of generating and receiving events in the old architecture, but this latter facility is now implemented by the USC. The implementation of KM_PEV in the USC is done in the same classes as listed for KM_EVIF, i.e.
USC_Transaction
USC_EventManager
USC_Winsock
USC_RegisteredObject
USC_NotifyInfo (just hold data)
USC_DataEvent (just hold data).
   KM_PSS (used only by User Controls, e.g. by a subsystem editor that supports multiple platforms, USC implements interface): this KM allows a subsystem to use platform specific data such as control and display data. For example, a new tab could be introduced into a subsystem's platform specific tab which is also used by other subsystems. It consists of an interface, a GUI control (a tabbed control), an implementation within the USC of the interface, and supporting table structures in the subsystem definition tables.
   KM_STFL (used by subsystem developers to sort and filter grids, some algorithms may also use the mechanism to sort and filter other data structures, USC implements interface): this KM allows filter/sort to be represented in the same way for all types of data. This is achieved through the implementation of a common pattern, a standard GUI, and the facility for cascaded filters such as required by the SysDB component. The USC provides an implementation of the Sort/Filter interface that defines the attributes that can be sorted or filtered upon.

The public KMs unchanged by USC, but are used by USC are described in more detail below:

KM_EVRH (used by any code that needs to report errors, unchanged by USC, additional access provided by USC): this KM allows any code to send trace messages to a single location, and is used by subsystems and by the USC. The USC does not make any changes to this KM. In addition, the USC provides a means for scripts to easily output trace via this KM. The implementation of this facility is provided in the USC in the following USC classes:
USC_ScriptObject
USC_Global
   KM_GCC (used by GUIs, including by some GUIs provided by the USC itself, unchanged by USC): the USC does not make any changes to this KM. GUIs use this KM, including some GUIs provided by the USC itself.
   KM_INST (used only by HOAP and by USC under normal circumstances, unchanged by USC): this KM provides installation data that is used at run-time to modify software behaviour or appearance, e.g. the caption in the Host Application. This KM is not to be used directly by any subsystem, other than HOAP. There is, however, an option to use it directly if something very bespoke is required. The USC is a client of this KM, but does not make any changes to this KM. There is an opportunity to take the file that INST uses and put its contents into the USS database. This saves installing the file on all the workstations.
   KM_NWIN (used by GUIs, including by some GUIs provided by the USC itself, and by HOAP, unchanged by USC, additional access provided by USC): this KM allows subsystems to open new windows within the Host Application. The USC does not make any changes to this KM, but provides procedures which use this KM to implement common sub-flows for causing new windows to be opened. These procedures are invoked via the data tables as explained in more detail below, and are not called directly by subsystem code. These procedures are provided by the following USC classes:
USC_InternalAction_Edit
USC_InternalAction_EditTopItem
USC_InternalAction_View
USC_InternalAction_ViewTopItem

There is only one public KM which is unchanged by USC, not used by USC:

KM_STUP (used only by the HOAP, not used by USC, unchanged by USC): this KM finds the registered subsystems such that they can be displayed in the Host Application navigation view. The USC does not make any changes to this KM, and the USC has nothing to do with this KM (bearing in mind that KM_STUP now gets its data from KM_INST). KM_STUP is used only by the HOAP.

For the private KMs which are not directly visible to subsystem or HOAP developers (other than sometimes indirectly as data entries in subsystem definition tables), there are several with interfaces implemented by USC:

KM_AFF (some interfaces implemented by USC): this KM ensures that relationships between data items from different subsystems (which are represented using Monikers, see the description of KM_MKR below) are only created where they are compatible. The USC will have to talk to KM_INST (see below) in order to read the valid relationship and associations from the INST database. The USC will implement some interfaces of KM_AFF for its own use. The implementation of these interfaces will probably be in the following USC classes:
USC_Class
   KM_ANA (interface implemented by USC): the KM provides a standard interface between an ambiguity analyser and an item to be analysed. The USC will provide an implementation of this interface.
   KM_CCI (interfaces implemented by USC): this KM is used by subsystems (indirectly via the USC) to handle the CCI life cycle of a Key Abstraction. This KM provides a common state engine for the configuration management on all components under configuration control (CCI). Subsystems use this KM to handle the CCI lifecycle of a Key Abstraction. An element starts its lifecycle as ‘in-work’ and inconsistent. It progresses through a number of in-work sub-states before either being abandoned or issued whereupon it becomes available, usurping any existing ‘available’ versions. Existing ‘available’ versions advance to a state of ‘superseded’. The reusable components from the recently-revised KM_CCI (main logic plus common GUIs) will be used unchanged in the USC. CCI definition data (i.e. whether a class is subject to CC, and if so whether full or reduced CCI) is provided in subsystem definition tables. The USC will provide implementations of the revised KM_CCI interfaces.
   KM_DLK (interfaces implemented by USC): this KM provides a coding pattern and COM interfaces that allow subsystems (indirectly via the USC) to implement functionality related to links between: (1) generic data items from the SYS (System Database) subsystem; and (2) specific data items from any ESDB subsystem. The USC provides for entries in the subsystem definition tables (attributes table) to indicate where collections are of a docked subsystem's data.
   KM_MKR (interface implemented by USC): this KM is the means of implementing the relationships between data items contained in different subsystems. A moniker is a token that represents a data-item in the database. It is also the means by which the real data-item may be retrieved using the information it contains, given that each subsystem has no knowledge of any other subsystem's data-items. The USC will determine for itself whether an object or set relationship is a moniker-maintained relationship (from the fact that a Unique Item is involved), in which case the subsystem developer does not even need to create data table entries for monikers.
   KM_PLK (interfaces and behaviour implemented by USC): this KM provides a standard mechanism for locking objects in the database. COM clients of persistent data need to be able to apply locks to prevent other clients attempting to modify the same data. This KM provides a suitable locking mechanism and determines how locking is implemented by Entity/Data components. The USC provides the implementation of the KM's interfaces and behaviour in the USC class USC_DataItem as well as those for KM_PEV, i.e.
USC_Transaction
USC_EventManager
USC_Winsock
USC_RegisteredObject
USC_NotifyInfo (just hold data)
USC_DataEvent (just hold data).

The transmission mechanism across the network is the same as for KM_PEV.

KM_REP (USC probably replaces this with standard command handler): this KM provides a standard mechanism that allows a subsystem to generate XML and HTML reports. This KM may disappear completely with the USS—to be replaced by a command handler associated with the Unique Item Class in the Core layer, and hence is obtained automatically by inheritance by all items derived from Unique Item.

KM_SST (interfaces implemented by USC): this KM defines how MDS subsets are to be managed by the owning subsystems and how the MDS subsystem interfaces to them. This KM provides a pattern for the implementation of MDS subset functionality. The USC provides implementations of the interfaces. The class tables in the subsystem definition tables indicate whether the class is a subset. The USC provides the interface implementations in the following USC class:
USC_Entity
   KM_SUB (interface implemented by USC): this KM provides a common pattern for developing subsystems, based on three layered components in each subsystem: GUI, Logic and Entity, with an interface that allows the HOAP to determine information about the subsystem. With the USS, only the interface is relevant (i.e. the pattern is no longer relevant). The interface is implemented in the following USC class:
USC_Entity

There is only one private KM unchanged by USC:

KM_SECR (used unchanged by USC): this KM allows the subsystem (indirectly via the USC) to determine whether the current user has the correct privilege to perform an operation. The KM works in conjunction with the User Admin subsystem (UAD). The USC is a client of the KM. It calls this KM on the subsystem's behalf when a command handler is created and invoked.

There are a few private KMs which have not yet been categorised to fit into the above categories:

KM_XIC: this KM is used to translate databases to and from XML. It is used for importing and exporting databases. The USC is a client of this KM.

KM_XIO: this KM is used to translate data items to and from XML, and for bulk transfers between subsystems. The USC does not get involved with walking data (when reading the data out). The USC is involved in reading data from XML into the database.

The USS has Reusable Assets which are divided into:

Core Reusable Assets (part of the USC).

Domain-Specific Reusable Assets (not part of the USC, constructed as separate .DLL files).

Core Reusable Assets carry out the following:

Create Command Handler.

Delete Command Handler.

Domain-Specific Reusable Assets are provided by the USC (e.g. “Edit Parametric Line” command handler). Each such asset can be used with data associated with the concrete layer derived from this domain.

An explanation of terms used above are given in Table 4 below:

TABLE 4

| | |
|---|---|
| ActiveX Controls | Microsoft ActiveX Controls, formerly known as OLE controls or OCX controls, |
| | are components (or objects) you can insert into a Web page or other |
| | application to reuse packaged functionality someone else programmed. For |
| | example, the ActiveX Controls that are included with Microsoft Internet |
| | Explorer version 3.0 or higher allow you to enhance your Web pages with |
| | sophisticated formatting features and animation. |
| | An ActiveX control is a COM class that provides an implementation of an |
| | agreed set of COM interfaces that allow the COM class to be displayed by an |
| | ActiveX control container. The Host Application provides the ActiveX control |
| | container for each IMSS Child Window. |
| | ActiveX Controls can be written in both Visual Basic and VC++ and the MS |
| | tools provide extensive support for their development. |
| Actor | Represents a coherent set of roles that users of Use Cases play when |
| | interacting with Use Cases. Typically, an Actor represents a role that a |
| | human, a hardware device, or even another system plays with a system. |
| | (UML term.) |
| Component Object Model | A software architecture developed by Microsoft that: |
| | Defines a binary standard for component interoperability |
| | Is programming language-independent |
| | Is provided on multiple platforms (Microsoft Windows, Microsoft |
| | Windows NT, Apple Macintosh, UNIX) |
| | Provides for robust evolution of component-based applications and |
| | systems |
| | Is extensible. |
| Core (Concept) | Note that the word “core” has two related connotations in this document: |
| | 1. The USC is a component that forms the common core of any subsystem |
| | built using the USS. |
| | 2. Data (and corresponding functionality) in IEWMSS is split into three levels |
| | of specialisation: Core, Domain and Concrete, as defined as “classes and |
| | attributes common to the majority of MIEWS elements and data sets”. |
| | The USC provides much of the functionality of the Core level. |
| Concrete (Concept) | Defined as the level at which Classes and Attributes can be completely |
| | specified, and can inherit properties from the Domain Concepts and Core |
| | Concepts. |
| Core Pattern | What are now described as “Core Patterns” were identified as common Use |
| | Case patterns. They were intended to ensure that all Use Cases follow the |
| | same approach to common types of subflow or alternative flow. |
| Domain (Concept) | Defined as “Core Concepts” that are extended into the Domain but are still |
| | Abstract Classes. It is not possible to completely specify classes and |
| | attributes at this level, but the properties of these classes can be reused at a |
| | lower level. |
| | The USC provides domain-specific Reusable Assets (e.g. “Edit Parametric |
| | Line” command handler). Each such asset can be used with data associated |
| | with the concrete layer derived from this domain. |
| Entity/Data Component | An Entity/Data component is a major part of an IMSS subsystem. It provides |
| | support for persistent objects and provides implementations of interfaces used |
| | by the various GUI components (e.g. ImiewsRenderedItem). |
| | The USS makes a major change to the way in which such a component is |
| | constructed. |
| GUI Controller | A reusable component (not part of the USS at present, although it may be in |
| | future) which mediates events between the Entity Component and GUI |
| | Controls. It also facilitates the hook-up between the GUI and the GUI |
| | Controls. |
| Host Application | The Host Application is an MDI container that presents “visible” subsystems to |
| | the user, without being dependent on any details of those subsystems. |
| IMSS Application | The IMSS Application, which is single-threaded, can be viewed as comprising |
| | the Host Application and a number of subsystems. |
| Key Abstraction | An analysis of a coherent set of user data, e.g. the user's Equipment Specific |
| | Database. Note that this analysis uses an object oriented data model, rather |
| | than a relational database model. |
| | Key Abstractions are important drivers for the design of “Group 1” subsystems |
| | (in particular, the Entity Component of such subsystems). |
| Key Mechanism | Key Mechanisms (KMs) characterise, and in some cases realise, significant |
| | and common interfaces, conventions and behaviours of IEWMSS software. |
| | All external interfaces and interactions of subsystems are specified and |
| | realised using Key Mechanisms. |
| | Note that a Key Mechanism is defined in the Rational Unified Process as “A |
| | description of how an architectural pattern is realised in terms of patterns of |
| | interaction between elements in the system” . This is described in the patent |
| | application mentioned above. In the IMSS architecture, a Key Mechanism is |
| | an extension of this concept |
| | Compared to the previous architecture, the USS does not require subsystem |
| | developers to know many details about Key Mechanisms. |
| Previous Architecture | The software architecture used in a previous system |
| Reusable Asset (in the | As described above. |
| context of the USS) | |
| Subsystem | A subsystem in IMSS is a major unit of software that can be independently |
| | designed and developed. |
| Subsystem Definition Table | These tables have the same form for each subsystem. They specify the |
| | nature of the actual data to be stored with each subsystem, and they also |
| | contain and/or point to action components that are to be executed in |
| | conjunction with this data (e.g. command handlers, consistency checkers). |
| | Further information is provided in the patent application mentioned above. |
| Universal | A single, standard data-driven component of the USS that carries out much of |
| Subsystem Core (USC) | the functionality that is common to many IMSS subsystems, this common |
| | functionality being formally defined at present by Core Patterns. |
| | Note that the word “core” has two related connotations here: |
| | 1. The USC is a component that forms the common core of any subsystem |
| | built using the USS. |
| | 2. Data (and corresponding functionality) in IMSS is split into three levels of |
| | specialisation: Core, Domain and Concrete. The USC provides much of |
| | the functionality of the Core level. |
| | The position of the USC within the USS is illustrated in FIG. 2. |
| Use Case | A description of a set of sequences of actions, including variants, that a |
| | system performs to yield an observable result of value to an Actor. (UML |
| | term.) |

The development process is an object oriented process which is based on Rational's unified process. It focusses on use cases and software architecture and supports both component based development and interactive development.

The development platform is PC-based and uses the Rational suite and Microsoft™ Visual Studio suite (which includes Visual C++ and Visual Basic).

The process that must be undertaken when developing a subsystem requires that a series of steps be followed on a step-by-step basis. These steps are (i) populate the subsystem definition tables with data from the Class and Attribute Specifications; (ii) populate the subsystem data tables; (iii) connect the GUI to the database; (iv) add command handlers to provide context menus; (v) add scripts to provide algorithmic functionality; and (vi) conduct reviews of database tables and scripts. Each of these steps requires data to be entered into the database tables and/or the GUI forms.

In addition, utilities are provided within the Host Application to aid with specific steps. These comprise:

a Schema Generator (used to create the empty database definition tables prior to step (i) above)

a Make Reg File (used to create a registry file and assign a ProgID for the subsystem prior to step (i) above)

a StateBit Calculator (used to identify the values that correspond to each statebit for use within the database tables and algorithms and is used in steps (i) and (v) above)

Make User Tables (used to verify and populate the subsystem data tables as in step (ii) above)

a EVRH Viewer (used to identify the source of problems when running the Host Application and can be used at any point from step (iii) onwards once the GUI has been connected to the database)

a Subsystem Developer (which provides an alternative approach to editing scripts in step (v) above).

A mapping between Class and Attribute Specification headings and database tables are shown in Table 5.

TABLE 5

| | Figure No. | Database Table:Column |
|---|---|---|
| Class Name | 2 | Class_Description:ClassName |
| Description | 2 | Class_Description:ClassDescription |
| Internal Rules | 9 | Class_Description:InternalRules |
| Internal Warnings | 9 | Class_Description:InternalWarnings |
| External Rules | 9 | Class_Description:ExternalRules |
| External Warnings | 9 | Class_Description:ExternalWarnings |
| Notes | 2 | Class_Description:ClassNotes |
| Attribute Name | 2 | Attribute_Description:FieldName |
| | | Attribute_Description:FieldDisplayName |
| Description | 2 | Attribute_Description:FieldDescription |
| Display Properties | 7 | Attribute_Description:ToolTipAction (+possibly |
| | | Attribute_Description:ToolTip) |
| | 12 | Attribute_Description:DefaultStateBits |
| Valid Values | 3 | Attribute_Description (data may need to be |
| | | entered in many columns within this table) |
| Initial Value | 6 | Attribute_Description:InitialValue |
| Source | 6 | Attribute_Description:Persistence |
| | 8 | Attribute_Description:AlgorithmGetAction (+Actions |
| | | table if an action is referenced) |
| Tolerance | 7 | Attribute_Description:TolerancedAction |
| | | (+ Actions table if an action is referenced) |
| Notes | 2 | Attribute_Description:FieldNotes |

Each step will now be described in more detail.

In step (i), three stages are required to populate the subsystem definition tables with data from the class and attribute specifications. The first of these stages is to examine the relevant data model class diagrams to determine which classes will be added to the definition tables. FIG. 6 shows an example data model for Zeus ESDB, highlighting all concrete classes that should be added to the definition tables in grey.

The second stage is, for each concrete class identified, to use the corresponding Class and Attribute Specification to add a new entry into the UEC_Class_Description table, including the Class Name, Class Table, Class Description and Class Notes. Further values may be added to the appropriate columns when required.

The third stage is, for each attribute within a class, to create a new entry in the UEC_Attribute_Description table. All details are taken from the corresponding C&A Specification (see FIG. 7 for details of values to be entered in each column). FIG. 7 shows the relevant information that should be referenced for each section of the C&A Specification, and the corresponding database tables. Where a class inherits from other classes, the C&A Specification will not include all the inherited attributes, but only those that contain values to be overwritten. Consequently, the C&A Specifications for the inherited classes are used to enter all of the attributes required for the concrete class. The process of adding the necessary values for each of the attributes may require a new entry to be added to the ‘UEC_Actions’ table, if for example, an algorithm, specialisation, or tolerance algorithm is referenced. Only placeholder entries are created at this stage. The scripts are added later, as specified in step (v).

In step (ii), the subsystem data tables are populated by carrying out the following stages:

In stage 1, the Host Application is run so that it is possible to select ‘Make User Tables’ from within the Utilities within the Host Application (stage 2). In stage 3, the database name is entered in the dialogue box and the ‘Connect’ button is selected. As a result of this, the text ‘Connected to [database name]’ should appear in the dialogue window. In stage 4, it is necessary to select the ‘Validate’ button to perform various verification checks on the definition tables, the results of which are returned in addition to a dialogue box stating whether or not the tests were passed. Stage 5 checks for errors and any errors found should detail where the problem is, enabling correction and resolution of these in the database, before re-selecting ‘Validate’. Once all verification tests have been passed, select ‘Validate and Build User Tables’ (stage 6). This will create a new database table for each of the classes specified in the UEC_Class_Description table, and will create an entry in the tables of those classes that have an association with the top item.

For step (iii), the GUI forms may be readily available if they have already been developed—otherwise they will need to be created at this stage. Once completed, the GUIs must be connected to the database. Visual Basic (VB) is to be used to hook up the GUIs. This is achieved as follows:

In order to hook up the GUI to the subsystem definition tables, the developer will need a basic knowledge of Visual Basic (VB). This document outlines the steps required to connect fully the GUI to the database, and provides sample code to assist with this part of the process.

The steps required to connect the GUI to the definition tables, are outlined below:

Mapping GUI Controls to Database Attributes: creating an association between the GUI control and its corresponding database attribute.

Creating Object Associations Between Classes: implementing object associations by mapping them to their corresponding database attribute.

Creating Set Associations Between Classes: implementing set associations by mapping them to their corresponding database attribute.

Creating Tree List Structures: implementing a read-only browser.

Adding Command Handlers: implementing command handlers to provide the context menus.

Assuming the GUIs have previously been developed for the subsystem, the relevant VB project should be opened within the Visual Basic application. The project will comprise of a number of User Controls, each of which may be viewed in two alternative formats: a User Control Object View and a User Control Code View. It is possible to switch between the two views by selecting the appropriate option from the view menu, or the appropriate icon from the project explorer window on the upper right hand side of the screen.

There are two pre-requisites that must be addressed prior to commencing step one of this process, for any VB project:
1. Add the fundamental sub routines and functions required to provide the basic functionality for each user control. If there is no code behind each of the user controls (i.e. in the User Control Code View), right-click in the project explorer window, and select ‘Add, ‘User Control’, and the ‘NWIN Control’. This will display a new user control window containing code. Copy and paste the code in the new user control window into each of the other user controls.
2. Add a pre-defined module containing a number of generic, public sub routines applicable to all user controls. Select the ‘modules’ folder within the project explorer window, and right-click, selecting ‘Add’, ‘Module’. Select ‘existing’ and navigate to: X:/include/ . . . bas and select ‘open’.

On completion of the aforementioned pre-requisites, the developer is provided with the basic code upon which they will now build to associate the user controls with the subsystem definition tables.

At the top of the user control code view for each user control, a number of variables are declared and defined, including a variable called ‘m_DataItem’, which references the class from which all others stem (e.g. the ESDB or the emitter). However, as each user control contains this consistently named variable, it might be preferable for the developer to rename the variable to reduce confusion over the data item referenced in each user control. It is recommended that this should be modified at the onset because this variable is used throughout the process of connecting the GUI to the database.

To do this, the name of ‘m_DataItem’ should be changed to that of the top level class name, e.g. ‘m_ZeusRFRxEmitter’ for the Emitter GUI form, as shown by the code below:

Dim m_DataItem As KMENT.IKMENT_DataItem

Changed to:

Dim m_ZeusRFRxEmitter As KMENT.IKMENT_DataItem

Furthermore, if a section of the GUI form is specified on another form, for example the details tab of the emitter form, the value of the top level data item will need to be passed to it. This is achieved by adding the following line of code to the ‘PopulateControls’ method as described below for the parent GUI form (e.g. the Emitter form), and copying the line of code as shown above for declaring the data item, to the top of the details form:

```
Private Sub PopulateControls( )
    Call...
    ...
    Set ctlZRFEmitterDetails1.DataItem = m_ZeusRFRxEmitter
End Sub
```

Finally, a public property is defined in the details form, using the following code:

```
Public Property Set DataItem(p_RHS As IKMENT_DataItem)
    Set m_ZeusRFRxEmitter = p_RHS
    Call PopulateControls
End Property
```

Once the above code has been entered correctly, this will enable the referenced data item to be passed between the two GUI forms, and consequently called from the sub-GUI form.

With reference to the code samples provided herein, they may be entered under a private sub routine called ‘PopulateControls’, and that once all code has been entered, it is restructured into smaller ‘PopulateControl’ routines to increase the robustness of the code. This should be based upon groupings of GUI controls within the same class, grid controls, or tree list structures, i.e. all code relating to one grid should be within a sub routine, for example:

```
Private Sub PopulategrdExample( )
Dim a_MT As KMEVRH.KMEVRH_VBMethodTracer
Set a_MT = m_CT.GetMethodTracer(“IKMNWIN_Control”, “Startup”)
On Error GoTo EH
    ‘all code relating to the grid goes here...
Exit Sub
EH:
  a_MT.KMEVRH_VB_TRACE_ERROR_HIGH Err.Description
  Set a_MT = Nothing
  MsgBox Err.Description, vbOKOnly,
  “GUI Form Name::PopulategrdExample”
End Sub
```

The above code includes functionality to provide an error trace to help identify the source of any problems found when running the Host Application. The primary benefit of restructuring the code into separate sub routines for each populate method means that if there is a problem with one grid, it will not prevent others from being displayed correctly. If an error occurs, a message box is displayed, indicating which populate method has triggered the event, which in turn allows the user to identify where the problem is located.

If the user is confident enough to omit the intermediate step of adding all functionality under one sub routine, they may do so and create the segregated sub routines immediately. However, it should be noted that the danger of omitting this step could return additional errors on compilation if the attributes and associations are not grouped together correctly.

Once all populate methods have been restructured, the sub routine ‘PopulateControls’ should call each of the others, as defined below:

```
Private Sub PopulateControls( )
    Call PopulategrdExample
    Call PopulateExample2
    Call PopulateExample3
    ...
End Sub
```

In order for the step of mapping GUI controls to database attributes to be achieved, the GUIs need to be designed. Once the GUIs have been designed, code needs to be written to connect the various GUI controls to their corresponding database attributes. The initial step is to associate each control with the correct attribute name from the database. This will ensure the correct mapping of controls to attributes, as in some cases this may not be obvious from the control name. FIG. 14 provides an overview of how the various artefacts are associated.

An example will now be explained with reference to FIG. 20 and Table 6. FIG. 20 shows an example GUI layout, with the control ‘Name’ highlighted. By selecting this field, the control properties are displayed on the right-hand side of the window, including the control name, also highlighted. This name will be used in the code.

Table 6 below shows the ‘GUI Name To Data Model Conversion’ mapping table. Other tables are also included which show mapping in both directions, i.e. the Data Model To GUI Name Conversion, and the GUI Name To Data Model Conversion, which aids finding an attribute.

The example GUI layout in FIG. 15 is for the general tab from the Zeus ESDB Browser form. Using this information, the corresponding database attribute can then be found for the subsystem being developed, as shown via the highlighted row in Table 2. The details from the ‘Data Model’ column can then be used to identify the database class and consequently the correct attribute name. Note that the data model diagrams may be used to aid identification of the class implemented in the database as although inheritance is not supported by the database tables, this is not reflected in the mapping tables, as in the example shown in Table 6, where the database class would be ‘Zeus RF Rx ESDB’.

TABLE 6

| GUI Location | | Data Model |
|---|---|---|
| Form/Tab/Frame | Field Name | Diagram::Class::Attribute |
| ZeusESDB_Browser/General/ | Ext | Zeus ESDB Dataset Diagram/Zeus RF Rx ESDB: |
| Identity | | Identity::Reference Identifier Extension |
| ZeusESDB_Browser/General/ | ID Ref | Zeus ESDB Dataset Diagram/Zeus RF Rx ESDB: |
| Identity | | Identity::Reference Identifier |
| ZeusESDB_Browser/General/ | Name | Zeus ESDB Dataset Diagram/Zeus RF Rx ESDB: |
| Identity | | Unique Item (UI)::Primary Name |
| ZeusESDB_Browser/General/ | Type | Zeus ESDB Dataset Diagram/Zeus RF Rx ESDB: |
| Identity | | Identity::Type |

The following code sample shows how to map the ‘edtName’ control to its equivalent database attribute, ‘PrimaryName’:

Set edtName.RenderedItem=m_DataItem.GetRenderedAttribute(“PrimaryName”)

In this line of code, the reference to ‘m_DataItem’ is whatever the top-level data item has been defined as (e.g. it could be ‘m_ZeusRFRxEmitter’ but this must have been assigned prior to using it).

This code example should be used to map all of the controls within each of the forms, with the exception of grids and tree structures (‘grdReferences’ or ‘TreeList2’ for example). The control name is taken from the GUI form as shown above, and the attribute name, once identified, from the database table ‘UCE_Attribute_Description’.

For radio button GUI controls, additional code must be added, because two controls map to the same database attribute. In this instance, the following code should be included prior to the assignment of the control to the attribute:

radControlNameNo.EnumerationValue=0

radControlNameYes.EnumerationValue=1

A check should also be made to ensure the database attribute corresponding to the radio button is of type ‘ENUMERATION’, within the subsystem definition table ‘UEC_Attribute_Description’. It is possible that the initial value of the type is set to ‘BOOLEAN’, however this should be modified to enable complete functionality of the radio buttons.

The next stage is to add the ‘Object’ associations between the relevant classes, as defined in the data model or database tables as shown in FIG. 21. FIG. 21 is taken from the ZRF data model, and shows two object associations, with the top-level data item corresponding to the ‘Zeus RF Rx ESDB’ class. The name of the association between this class and the ‘Zeus RF Rx ESDB Property Data’ class is taken from the database attribute table, which is the same as the latter of the two class names. FIG. 22 shows the database entry for this association, highlighted. Note the field type of ‘OBJECT’ and the Field Name, which will be required when implementing this association in Visual Basic (VB).

Object associations are of the multiplicity value one-to-one, thus the association is created as a data item for the class because only one instance of it will exist for the ESDB/Emitter. The following code will create the association as a data item and pass it the name of the association as specified above:

Dim a_ZeusRFRxESDBPropertyData As IKMENT_DataItem

Set a_ZeusRFRxESDBPropertyData=

m_DataItem.GetAttributeValue(“ZeusRFRxESDBPropertyData’)

Any attributes that may be defined within the Zeus RF Rx ESDB Property Data class may then be mapped using the same code as specified previously, but by changing the reference from ‘m_DataItem’ as shown:

Set edtName.RenderedItem=

a_ZeusRFRxESDBPropertyData.GetRenderedAttribute(“PrimaryName”)

In order to create the second of the object associations between the classes Zeus RF Rx ESDB Property Data and Zeus ERP Polarisation Tolerances, the top-level data item can again be substituted for the newly defined data item.

Dim a_ZeusERPPolarisationTolerances As IKMENT_DataItem

Set a_ZeusERPPolarisationTolerances=

a_ZeusRFRxESDBPropertyData.GetAttributeValue(‘ZeusERPPolarisationTolerances”)

The code defined here is used to add all the object associations between the top-level data item and another class, and between classes already defined. It is possible that not all object associations will be created at this stage, for example, an object association that stems from a class which has a set association with the top-level data item.

Set associations generally have one class associated with zero, one or more instances of another class thus the association is implemented as a data collection to allow for this. There are various set associations that will be encountered, each being catered for in a different manner. These include:

Creating a set association between an already defined class and a class that is implemented via a grid structure

Creating a set association that has a multiplicity of 0 . . . 1, which implies that if there is no instance of the ‘parent’ class, the ‘child’ class will not be editable by the user

Creating an object association that originates from a class implemented via a set association

Creating a set association between two grids

Object or set associations with non-visible classes

Before creating an association between a ‘typical’ class and a class whose attributes are specified in a grid format, the grid must firstly be defined in terms of the number of columns, column names, and the database attributes that map to each column. FIG. 23 provides an overview of how the relevant artefacts are associated in respect to a grid.

A specific example is now explained via the following code:

grdExample.AttributeCols=3

grdExample.ColAttribute(0)=“PrimaryName”

grdExample.ColAttribute(1)=“ReferenceIdentifier”

grdExample.ColAttribute(2)=“ReferenceIdentifierExtension”

grdExample.ColTitle(0) =“Name”

grdExample.ColTitle(1)=“Ref ID”

grdExample.ColTitle(2)=“Ext”

In the above code:

grdExample=the grid name as defined in the ‘properties’ window (see FIG. 20)

AttributeCols=3=the number of columns

.ColAttribute(0)=“”=the attribute that will reside in the first column, the name of which is taken from the database

.ColTitle(0)=“”=the column name to appear on the GUI, in the column number identified

It should be noted that VB is zero based, i.e. all references to columns, for example, begin with zero referencing the first column, one for the second column, and so on.

It is possible for a grid representing attributes of one class to reference attributes from another class. In this instance, the path name should be specified in the Column Attribute, using the following notation:

grdExample.ColAttribute(0)=“ClassName.AttributeName”

The order of the columns for each grid should be defined for the corresponding subsystem. However, it is possible for a grid to require the merging of two or more cells for a heading as shown in FIG. 24. In this instance, the columns for the grid must be defined in a slightly different manner using the following code:

grdTrigDwellFreq.AttributeCols=6

grdTrigDwellFreq .ColAttribute(0)=“TriggeredFrequency”

grdTrigDwellFreq.ColAttribute(1)=“DwellNumber”

grdTrigDwellFreq.ColAttribute(2)=“LSBRFMin”

grdTrigDwellFreq.ColAttribute(3)=“LSBRFMax”

grdTrigDwellFreq.ColAttribute(4)=“USBRFMin”

grdTrigDwellFreq.ColAttribute(5)=“USBRFMax”

grdTrigDwellFreq.MergeCells=2

grdTrigDwellFreq.TitleRows=2

grdTrigDwellFreq.ColTitle(0)=“”

grdTrigDwellFreq.ColTitle(1) =“”

grdTrigDwellFreq.ColTitle(2)=“LSB RF (MHz)”

grdTrigDwellFreq.ColTitle(3)=“LSB RF (MHz)”

grdTrigDwellFreq.ColTitle(4)=“USB RF (MHz)”

grdTrigDwellFreq.ColTitle(5)=“USB RF (MHz)”

grdTrigDwellFreq.TitleRow=1

grdTrigDwellFreq.ColTitle(0)=“Frequency”

grdTrigDwellFreq.ColTitle(1)=“Dwell number”

grdTrigDwellFreq.ColTitle(2)=“Min”

grdTrigDwellFreq.ColTitle(3)=“Max”

grdTrigDwellFreq.ColTitle(4)=“Min”

grdTrigDwellFreq.ColTitle(5)=“Max”

Note that the column attributes are defined in the same way as before, but the last three sections of code differ. The method ‘MergeCells’ is used to specify the circumstances under which cells are to be merged, with the value 2 corresponding to adjacent rows containing the same information. The method ‘TitleRows’ specifies the number of rows that will contain column headings, which is two in this instance. The first set of column titles are automatically set to the first title row. Note that where there is only one column title to be entered in the second row, it is set to empty for the first row. The values of the second title row are then set using the values specified from the bottom row of the table in FIG. 24.

An important point to note is that the width of columns is not explicitly defined. However, although this is not defined as a requirement, and the column widths are up to the discretion of the developer, the above should be adhered to, e.g. allow a column width to display the full length of the longest enumeration value.

To specify the column width, the following code should be used:

grdExample.ColWidth(0)=1500

It should be noted that the default column width is 1000 twips.

Once the grid metrics have been defined, the association can be created between the grid and the class to which the association is with, using the code:

Set grdExample.DataCollection=m_DataItem.GetAttributeValue(“ExampleAssociationName”)

If a set association has a multiplicity of 0 . . . 1, this means that if an instance of the ‘parent’ class exists, the ‘child’ class will also exist (i.e. the child class attributes are also user-editable). FIG. 26 shows the relationship between classes with such associations.

The class Zeus RF Rx Emitter is the top-level data item in this instance. The class Zeus Triggered Dwell Parameters contains individually specified attributes, while Zeus Triggered Dwell Frequencies is implemented via a grid. The grid metrics for the latter class should be specified as before, but the association should not be created unless an instance of the Zeus Triggered Dwell Parameters class exists. This condition and the associations are implemented via the code:

Dim a_ZTDPCollection As KMENT.IKMENT_DataCollection

Set a_ZTDPCollection=

m_ZeusRFRxEmitter.GetAttributeValue(“ZeusTriggeredDwellParameters”)

If a_ZTDPCollection.Count>0 Then

Dim a_ZTDPltem As KMENT.IKMENT_DataItem

Set a ZTDPItem=a_ZTDPcollection.Item(0)

Set grdTrigDwellFreq.DataCollection=

a_ZTDPItem.GetAttributeValue(“ZeusTriggeredDwellFrequencies”)

End If

The above code sample creates the association ‘a_ZTDPCollection’ as a data collection, and assigns it to the corresponding database attribute name. A check is then made, using the ‘count’ method, to determine whether an instance exists. If the result is true (i.e. count>0), an instance is created as a data item (‘a_ZTDPItem’), and the first item in the collection assigned to it. The association between the classes Zeus Triggered Dwell Parameters and Zeus Triggered Dwell Frequencies is then created using the attribute name for the association from the database.

If a class has an object association that originates from a class with a set association, e.g. Free Text Notes in FIG. 26, the object association can only be added once the set association has been created.

The class ‘ZeusRFRxEmitter’ is the top-level class in the above example. The class Platform Specific Display and Control Data contains individually specified attributes, but the association to the class Free Text Notes should not be created unless an instance of the Platform Specific Display and Control Data class exists. This can be implemented via the code:

Dim a_PlatformSpecificDandCDataCollection As KMENT.IKMENT_DataCollection

Set a_PlatformSpecificDandCDataCollection

m_ZeusRFRxEmitter.GetAttributeValue(“PlatformSpecificDandCDatas”)

If a_PlatformSpecificDandCDataCollection.Count>0 Then

Dim a_PlatformSpecificDandCDataItem As KMENT.IKMENT_DataItem

Set a_PlatformSpecificDandCDataItem=a_PlatformSpecificDandCDataCollection.Item(0)

Dim a_FreeTextNotes As IKMENT_DataItem

Set a_FreeTextNotes=a_PlatformSpecificDandCDataItem.GetAttributeValue(“FreeTextNotes”)

‘define any further attributes here . . .

End If

The above code sample creates the association ‘a_PlatformSpecificDandCDataCollection’ as a data collection, and assigns it to the corresponding database attribute name. A check is then made, to determine whether an instance exists, and if the result is true (i.e. count>0), an instance is created as a data item (‘a_PlatformSpecificDandCDataItem’), and the first item in the collection assigned to it. The association to the class Free Text Notes is then created using the attribute name for the association from the database.

In some instances one class will be implemented via a grid (to add a set association), but another class may also have a set association with it, implemented via a grid. FIG. 27 shows how this is denoted in the data model.

With reference to the above example, assume the RF Rx Emitter Function and User-Defined Specific Function classes are both implemented via grids. The association between As Parent and RF Rx Emitter Function has been added as outlined in section above, using the code:

grdRFRxEmitterFunction.AttributeCols=2

grdRFRxEmitterFunction.ColAttribute(0)=“EmitterFunction”

grdRFRxEmitterFunction.ColAttribute(1)=“EmitterFunctionPriority”

grdRFRxEmitterFunction.ColTitle(0)=“Function”

grdRFRxEmitterFunction.ColTitle(1)=“Priority”

Set grdRFRxEmitterFunction.DataCollection=

a_AsParent.GetAttributeValue(“RFRxEmitterFunctions”)

The class User-Defined Specific Function is only available if an event is performed on the RF Rx Emitter Function class, thus although the grid metrics are defined in the same way, the association is not specified at present. Instead, create a new sub procedure outline as follows:

Private Sub grdEmitterFunction_Click( )

‘grdSpecific Function

End Sub

This means the code within this sub routine will be executed when the user performs a mouse click on any attribute within the RF Rx Emitter Function grid.

Whilst it is possible to identify all attributes used in the GUIs, it will be understood that some of these attributes are not visible to the user. It is possible to have classes that contain a single non-visible attribute, or classes that have all non-visible attributes. Where the entire class is non-visible, an association does not need to be created in the GUI—it exists only in the database tables.

A type of control that is specified in a different manner to those previously described is that of the tree list structure. A tree list structure is generally used for a browser where the contents displayed are required to be read-only.

The following code is used to implement this:

Call TreeList2.Layout.Columns.Add(“Name”, 130)

Call TreeList2.Layout.Columns.Add(“ID Ref”, 60)

Call TreeList2.Layout.Columns.Add(“Ext”, 60)

Call TreeList2.Layout.Columns.Add(“RF (MHz): Min”, 100)

Call TreeList2.Layout.Columns.Add(“RF (MHz): Max”, 100)

Call TreeList2.Layout.Columns.Add(“PRI (ps): Min”, 100)

Call TreeList2.Layout.Columns.Add(“PRI (ps): Max”, 100)

‘set TopItem specs

Dim objDataItemType1 As KMGCC_TreeListCtl.IKMGCC_TreeListDataItemType

Set objDataItemType1=TreeList2.Layout.DataItemTypes.Add(“Zeus RF Rx Emitter”)

Call objDataItemType1.AttributeMappings.Add(“PrimaryName”, “Name”)

Call objDataItemType1.AttributeMappings.Add(“ReferenceIdentifier”, “ID Ref”)

Call objDataItemType1.AttributeMappings.Add(“ReferenceIdentifierExtension”, “Ext”)

Call

objDataItemType1.AttributeMappings.Add(“ZeusRFRxEmitterCalcSummaryData.Min_MinRF”,

“RF (MHz): Min”)

Call

objDataItemType1.AttributeMappings.Add(“ZeusRFRxEmitterCalcSummaryData.Max_MaxRF”,

“RF (MHz): Max”)

Call

objDataItemType1.AttributeMappings.Add(“ZeusRFRxEmifterCalcSummaryData.Min_MinPRI”,

“PRI (ps): Min”)

Call

objDataItemType1.AttributeMappings.Add(“ZeusRFRxEmitterCalcSummaryData.Max_MaxPRI”,

“PRI (ps): Max”)

TreeList2.DataSource=m_DataItem.GetAttributeValue(“ZeusRFRxEmitters”)

TreeList2.Transaction=m_Transaction

Call TreeList2.Populate

In accordance with step (iv), the command handlers and their corresponding actions must now be added to the relevant database tables, and connected to the GUIs in order to provide context menu options.

First, the relevant use cases should be examined to determine which subflows are to be added as command handlers. For example, for the ZRF subsystem the subflows from the use cases ‘Maintain RF Rx ESDB’, ‘Edit RF Rx ESDB Element’ and ‘Edit Subset RF Rx ESDB Element’, should be considered. Common examples include view, edit, delete, copy and new (create subflow). It should be noted that not all subflows necessarily correspond to a menu item. For example, the close or exit subflows are implemented via the close window icon, and the edit data field subflow is equivalent to a user editing a field within the GUI, thus neither require a menu option to provide this functionality. The context of each subflow should therefore be considered as to whether a menu option needs to be provided. Furthermore, any subflows that correspond to a Key Mechanism (KM), for example Configuration Control and Checking, Filter and Sort, Generate Reports, etc., should also be excluded from the menus, as this functionality will be provided later.

Secondly, it is necessary to identify whether each subflow belongs to an item or set command collection. Here, it should be noted that there are two types of command collections to which a menu option may belong; Item Command Collections or Set Command Collections. An item command collection refers to an action to be performed on one “item”, e.g. edit, view, delete, etc. A set command collection refers to an action to be performed on a set of “items”, e.g. filter/sort, new (create).

Thirdly, the top-level command collection is entered into the database table ‘UEC_Command_Handlers’, followed by the various item and set command collections. FIG. 9 details the values to enter in each of the columns.

Fourthly, actions for the command handlers need to be created. On entering the actions, there are a number of possible action types, comprising Internal Operations, Scripts, and External Operations. Internal Operations provided by the USC are listed in Table 7 below. To determine the action type, examine Table 7 to identify if an internal operation may be used, else additional scripts may need to be developed, or an external COM object identified via the ProgID. It is to be noted that in some instances one action may be applicable to many menu options, and in this situation only one action should be created, but referenced by many command handlers.

TABLE 7

| Internal Operation | Description |
|---|---|
| Copy | Copy an item into the same collection |
| Create | Create an item |
| Delete | Delete an item |
| View | View an item |
| Edit | Edit an item |
| OpenTopItem | Open the top-level item for edit |
| OpenTopItemReadOnly | Open the top-level item for read only |

Fifthly, the reference between the class table and the command handler table is added, using the ‘ItemCommandCollection’ and ‘SetCommandCollection’ columns of the table ‘UEC_Class_Description’, details of which can be found in FIG. 10. If a command collection applies to more than one class, the same command handler IDs must be entered in the columns for each class.

Lastly, the database command collections are to be connected to the GUI, via function calls where context menus are required. The sample code to add to the GUI forms in order to connect the context menus to the database and provide the correct menu options for each instance is given below.

The module provided contains the public sub routines required to create the context menus for both grid and tree list structures, called DoGridContextMenu and DoTreeListContextMenu respectively. Consequently, only minimal code is required to create individual instances of context menus for each GUI form.

By double-clicking on a grid for which a context menu is to be created, the code will be switched with a newly created sub routine outline. For example:

Private Sub grdExample_Click( )

End Sub

By select the right drop-down menu, currently displaying ‘Click’, and select ‘OnContextMenu’ which creates a new sub routine outline, the former of which, as shown above can now be deleted.

In order to connect the control to the database, the DoGridContextMenu needs to be called, passing in the correct parameters, via the code:

Private Sub grdExample_Click( )
DoGridContextMenu UserControl.hwnd, grdExample

End Sub

Once this has been added for each of the grids requiring a context menu, any tree list structure command handlers can be added in the same way but by calling the sub routine DoTreeListContextMenu instead, via the code:

Private Sub grdExample_Click( )
DoTreeListContextMenu UserControl.hwnd, KMGCC_TreeListNode, TreeListExample

End Sub

Upon connecting the tree list context menus to the database, the process is now complete.

Following completion of the above steps, it is expected that the code behind the GUIs will require compilation in order to confirm there are no errors, and that the GUI controls are correctly connected to the database tables.

This is accomplished by selecting ‘Make [VBProject Name].ocx’ from the File menu, and selecting a location from the ‘Make Project’ window. Compilation will not complete if any errors are present, and the first error encountered, if any, will be highlighted on screen for the developer to correct.

Once all errors have been corrected, the project will compile successfully, and the Host Application can be loaded to test the modifications made in the user control views.

The developer may choose to compile the code at any point, however it may prove more valuable post step (ii), particularly for the development of command handlers and the layouts of grids. Furthermore, it should be noted that it is useful to compile the code frequently, subsequent to developing new sections of code.

Frequent and successful compilation in essence equates to an informal, syntactical review of the code.

In step (v), scripts are added. This adds much of the functionality to the subsystem, by writing scripts to implement the algorithms behind each of the actions. VBScript will be used to add the scripts to the Action column of the Actions table, which contain a placeholder entry for each occurrence of an algorithm, specialisation, command handler, or tolerance value in the relevant Class and Attribute Specifications.

The script is entered into the database via one of two approaches, the first of which is to enter it directly into the database column. However, this approach does not allow for a structured layout of the script to enable ease of reading, but merely requires each line of code to be delimited by a colon.

The second approach provides an alternative method of entering the script while supporting a structured layout, hence aiding readability. This is provided by right-clicking on the Utilities icon within the Host Application, and selecting the option ‘Subsystem Developer’. The database name must then be entered in the text box, and the ‘Connect’ button selected, which will display a collapsed view of the classes and actions. On expanding the actions, selecting a single action, and right-clicking, it may be opened for edit. The script can then be entered in the main window, and the action context and action type changed accordingly. Note that if the Class and Attribute Specification contains data tables, complex equations or diagrams, these can be copied and pasted into the description tab.

It should be noted that on closing an action you will not be prompted to save any changes as this will only occur when the subsystem developer window is closed.

Whichever of the above approaches is taken, the two steps are as follows:

1. For each entry in the ‘UEC_Actions’ table, examine the corresponding C&A Specification to understand the description and content of the script that is to be developed.

2. Develop the script to implement the functionality of the algorithm, using one or more methods as defined below.

Methods and example scripts to be used in scripting the algorithms are described below.

This part of the process will add a large part of the functionality to the subsystem for calculating values to be displayed in various data fields, via the implementation of algorithms using VB Script. The complexity of algorithms varies widely hence the understanding of specific algorithms may require discussions with the author of the algorithm to aid development of the scripts. However, many of the algorithms encountered can be implemented with the inclusion of one or more methods created to aid script development (outlined below).

At this point, it should be noted that the subsystem developer requires a more in-depth knowledge of VBScript. If this pre-requisite is not met, the developer should undertake the VBScript tutorial within the MSDN library, and use the language reference to assist with script development. The tutorial and reference can be found under the following path, once the MSDN library has been selected from the start-up menu:

MSDN Library Visual Studio
Platform SDK
   Internet/Intranet/Extranet Services
      Scripting
         VBScript Language Reference
         VBScript Tutorial

Scripts can be divided into various categories, as defined by the ‘Action Context’ column within the database. The pre-defined methods provided are applicable to all categories, each of which will now be described in turn.

One method is RoundToleranceDown and is generally used for algorithms that return a ‘minimum’ tolerance value, where the value must be rounded down. The method and input arguments are outlined below, which returns a long or a real depending on the field type of the attribute the tolerance value is being calculated for:

ExampleTolerance=RoundToleranceDown(p_value, “ToleranceRoundDownMin”,

“ToleranceRoundDownThreshold”, “ToleranceRoundDownStep”)

In the above method declaration, the input arguments refer to the following:

p_value=the value of the attribute the tolerance value is being calculated for. Note that p_value can only be used in tolerance algorithms, but can be used whenever the value of the attribute needs to be returned.

ToleranceRoundDownMin=offset which is added to p_value. This may be specified as a string as in the example below, or simply as a number, where the value is known.

ToleranceRoundDownThreshold=the lower boundary valid value

ToleranceRoundDownStep=the step to which the value is rounded

The following is an example tolerance algorithm for an attribute called ‘Min Frequency’ as defined in its corresponding Class and Attribute Specification:

Min Frequency:

Toleranced Min Frequency=Min Frequency+Example::Tolerance_Frequency Min

Toleranced Min Frequency is then rounded down to the nearest Integer Multiple of Example::Round Frequency

IF Toleranced Min Frequency <10, THEN ROUND Toleranced Min Frequency up to 10.

The code below shows the values that must be entered in the RoundToleranceDown method in order to calculate the tolerance value for the Minimum Frequency.

MinFrequencyTolerance=RoundToleranceDown(p_value, “Example.Tolerance_Frequency_Min”, 10, “Example.RoundFrequency”)

Another method is RoundToleranceUp and is generally used for algorithms that return a ‘maximum’ tolerance value, where the value must be rounded up. The method and input arguments are outlined below, which returns a long or a real depending on the field type of the attribute the tolerance value is being calculated for:

ExampleTolerance=RoundToleranceUp(p_value, “ToleranceRoundUpMin”, “ToleranceRoundUpThreshold”, “ToleranceRoundUpStep”)

In the above method declaration, the input arguments refer to the following:

p_value=the value of the attribute the tolerance value is being calculated for.

ToleranceRoundUpMin=offset which is added to p_value. This may be specified as a string as in the example below, or simply as a number, where the value is known.

ToleranceRoundUpThreshold=the upper boundary valid value

ToleranceRoundupStep=the step to which the value is rounded

The following is an example tolerance algorithm for an attribute called ‘Max Frequency’ as defined in its corresponding Class and Attribute Specification:

Max Frequency:

Toleranced Max Frequency=Max Frequency+Example::Tolerance_Frequency_Max

Toleranced Max Frequency is then rounded up to the nearest Integer Multiple of Example::Round Frequency

IF Toleranced Max Frequency >100, THEN ROUND Toleranced Max Frequency down to 100.

The code below shows the attribute names and values that must be entered in the RoundToleranceUp method in order to calculate the tolerance value for the Maximum Frequency.

MaxFrequencyTolerance=RoundToleranceUp(p_value, “Example.Tolerance_Frequency_Max”, 100, “Example.RoundFrequency”)

The GetCount method is used to return a total number of items that exist for a specific emitter, for example. The method and input arguments are outlined below, which returns an integer:

GetNumberOfItems=GetCount(“Collection”, “Query”)

In the above method declaration, the input arguments refer to the following:

Collection=the collection name within which the items will be counted.

Query=the second input argument allows the user to specify a condition or query for the item via an attribute and value, i.e. only count the item if a particular attribute is equal to the value specified.

An example ‘get’ algorithm for an attribute called ‘Number of Items’ is shown below, as defined in its Class and Attribute Specification:

Number Of Items:

Set the Number of Items to the total number of items of the Emitter that have Example::Mode Modulation Type set to Pulse.

The code shown below identifies the values that must be entered in the GetCount method in order to calculate the total number of items. It should be noted that the value 0 is obtained by examining the enumeration column for the attribute in the database, to determine the position of the value ‘pulse’ within the enumeration. Thus the first position corresponds to zero, the second to one, etc., and this value is then entered in the method.

GetNumberOfItems=GetCount(“parent.Example”, “ModeModulationType=0”)

Another method is the GetSum method and is used to return the sum of the values for an attribute. The method and input arguments are outlined below, which returns an integer:

GetSum1=GetSum(“Collection”, “Attribute”, “Query”)

In the above method declaration, the input arguments refer to the following:

Collection=the collection name within which the specified attribute resides

Attribute=the attribute to be used in determining the sum of its values

Query=a query or condition on the attribute to determine whether it will be included in the final value

An example ‘get’ algorithm for an attribute called ‘Expendables Used’ is shown below, as defined in its Class and Attribute Specification:

Expendables Used:

A program may consist of up to 8 patterns, each pattern having a number of different types of expendables. For each type of expendable within a pattern, there will be a number of expendables associated with it.

Set Expendables Used to NumOfExpendablesUsed where Expendable Type is chaff, for a program.

The code below shows the values that must be entered in the GetSum method to calculate the expendables used. It should be noted that the value 0 is obtained by examining the enumeration column for the attribute in the database, to identify the position of the value ‘chaff’ within the enumeration. The position then indicates the value to be entered in the method, which is zero based.

GetExpendablesUsed=GetSum(“pattern”, “NumOfExpendablesUsed”, “ExpendableType=0”)

The GetMin method is used to return the minimum value of all values for an attribute. The method and input arguments are outlined below, which returns a long or a real depending on the field type of the attribute the minimum value is being calculated for:

GetMinValue=GetMin(“Collection”, “Attribute”, “Query”)

In the above method declaration, the input arguments refer to the following:

Collection=the collection name that contains the attribute for which the minimum value is required

Attribute=the attribute for which the minimum value is required

Query=a query or condition on the attribute to ascertain whether it is to be included in determining the minimum value returned

An example ‘get’ algorithm for an attribute called ‘Min_Min Frequency’ is shown below, as defined in its Class and Attribute Specification, which returns the minimum of all minimum frequencies:

Min_Min Frequency

Set the Min_Min Frequency to the minimum value of all the Example::Min Frequency values of the Emitter.

The code below shows the values that must be entered in the GetMin method in order to calculate the minimum of all minimum frequencies for an emitter.

GetMin_MinFrequency=GetMin(“parent.Example”, “MinFrequency”, “”)

The GetMax method is used to return the maximum value of all values for an attribute. The method and input arguments are outlined below, which returns a long or a real depending on the field type of the attribute the maximum value is being calculated for:

GetMaxValue=GetMax(“Collection”, “Attribute”, “Query”)

In the above method declaration, the input arguments refer to the following:

Collection=the collection name that contains the attribute for which the maximum value is required

Attribute=the attribute for which the maximum value is required

Query=a query or condition on the attribute to ascertain whether it is to be included in determining the maximum value returned

An example ‘get’ algorithm for an attribute called ‘Max_Max Frequency’ is shown below, as defined in its Class and Attribute Specification, which returns the maximum of all maximum frequencies:

Max_Max Frequency

Set the Max_Max Frequency to the maximum value of all the Example::Max Frequency values of the Emitter.

The code shown below identifies the values that must be entered in the GetMax method in order to calculate the maximum of all maximum frequencies for an emitter.

GetMax_MaxFrequency=GetMax(“parent:Example”, “MaxFrequency”, “”)

The GetStateBit method is Used to determine whether an attribute is set to a particular value as specified via a statebit, and is generally used where an algorithm specifies a condition, containing a check on whether an attribute is set to null, although alternative checks are also possible. Consequently, this method is commonly used in conjunction with additional methods for the development of an algorithm.

The statebit calculator should be used to determine the statebit to be entered for the second argument. In this case it is suggested the ‘Not_Applicable_Now’ statebit is used to determine whether the value is set to null, i.e. 256. The method and input arguments are outlined below, which returns a boolean value:

GetAttributeState=GetStateBit(“Attribute”, statebit)=true/false

In the above method declaration, the input arguments refer to the following:

Attribute=the attribute for which the statebit is to be examined

statebit=the value of the statebit to be examined

true/false=the boolean value used for comparison, i.e. whether you want to check the value equals the statebit specified, or not

An example ‘get’ algorithm for an attribute called ‘Threshold’ is shown below, as defined in its Class and Attribute Specification, which returns a value dependent upon the outcome of the GetStateBit method:

Threshold:

IF Example::ThresholdValue=Null then

Threshold=Example::ThresholdValue

Else

Threshold=Example::DefaultThreshold

The code shown below identifies the values that must be entered in the GetStateBit method in order to return the threshold based on whether the threshold value is set to null.

If getStateBit(“Example.ThresholdValue”, 256)=true then
Threshold=getValue(“Example.ThresholdValue”)

Else
Threshold=getValue(“Example.DefaultThreshold”)

End If

Another method is the GetValue method which is used to return the value of an attribute, and can be used within other methods, or on its own. The method and input arguments are outlined below, which returns a variant (long, real, string, object, . . . ), the type of which is dependent upon the field type of the attribute being returned:

GetAttributeValue=GetValue(“Attribute”)

In the above method declaration, the input arguments refer to the following:

Attribute=the path and attribute for which the value will be returned

An example ‘get’ algorithm for an attribute called ‘Attribute A’ is shown below, as defined in its Class and Attribute Specification:

Attribute A:

Set the value of Attribute_A equal to Example::Frequency_A

The code shown below identifies the values that must be entered in the GetValue method in order to return the value of Attribute_A.

GetAttribute_A=GetValue(“Example.Frequency_A”)

In step (vi), reviews of the database tables and scripts are conducted.

1-9. (canceled)

10. A method of generating a mission support system for a plurality of platforms, the method comprising the steps of:
a) defining a basic architecture for the mission support system;
b) deriving a universal subsystem from the architecture;
c) defining the universal subsystem in terms of a data model;
d) storing the data model in a relational database; and
e) interfacing with the relational database to adapt the mission support system for each of the platforms.

11. A method according to claim 10, wherein step d) comprises storing the data model in tables within the relational database.

12. A method according to claim 11, wherein the tables include subsystem definition tables and subsystem data tables.

13. A method according to claim 12, wherein step e) includes the further steps of:
f) populating the subsystem definition tables;
g) populating the subsystem data tables;
h) deriving a graphical user interface; and
i) connecting the graphical user interface to the relational database.

14. A method according to claim 13, wherein step f) includes the additional steps of:
j) selecting classes from the data model to add to the subsystem definition tables;
k) using a corresponding specification for each selected class to add a new entry in a class description table; and
l) for each attribute within a selected class, adding a new entry in a class attribute description table.

15. A method according to claim 14, wherein step g) includes the additional step of making a database table for each of the classes specified in the class description table.

16. A method according to claim 10, wherein step a) includes deriving a plurality of key mechanisms that are characteristic of the basic architecture.

17. A method according to claim 16, wherein step d) comprises storing the data model in tables within the relational database.

18. A method according to claim 17, wherein the tables include subsystem definition tables and subsystem data tables.

19. A method according to claim 18, wherein step e) includes the further steps of:
f) populating the subsystem definition tables;
g) populating the subsystem data tables;
h) deriving a graphical user interface; and
i) connecting the graphical user interface to the relational database.

20. A method according to claim 19, wherein step f) includes the additional steps of:
j) selecting classes from the data model to add to the subsystem definition tables;
k) using a corresponding specification for each selected class to add a new entry in a class description table; and
l) for each attribute within a selected class, adding a new entry in a class attribute description table.

21. A method according to claim 20, wherein step g) includes the additional step of making a database table for each of the classes specified in the class description table.

22. A method according to claim 11, wherein the key mechanisms comprise public key mechanisms and private key mechanisms.

23. A method according to claim 22, wherein step d) comprises storing the data model in tables within the relational database.

24. A method according to claim 23, wherein the tables include subsystem definition tables and subsystem data tables.

25. A method according to claim 24, wherein step e) includes the further steps of:
f) populating the subsystem definition tables;
g) populating the subsystem data tables;
h) deriving a graphical user interface; and
i) connecting the graphical user interface to the relational database.

26. A method according to claim 25, wherein step f) includes the additional steps of:
j) selecting classes from the data model to add to the subsystem definition tables;
k) using a corresponding specification for each selected class to add a new entry in a class description table; and
l) for each attribute within a selected class, adding a new entry in a class attribute description table.

27. A method according to claim 26, wherein step g) includes the additional step of making a database table for each of the classes specified in the class description table.

28. A method according to claim 12, wherein at least one of the public key mechanisms can be accessed in step e).

29. A method according to claim 28, wherein step d) comprises storing the data model in tables within the relational database.

30. A method according to claim 29, wherein the tables include subsystem definition tables and subsystem data tables.

31. A method according to claim 30, wherein step e) includes the further steps of:
f) populating the subsystem definition tables;
g) populating the subsystem data tables;
h) deriving a graphical user interface; and
i) connecting the graphical user interface to the relational database.

32. A method according to claim 31, wherein step f) includes the additional steps of:
j) selecting classes from the data model to add to the subsystem definition tables;
k) using a corresponding specification for each selected class to add a new entry in a class description table; and
l) for each attribute within a selected class, adding a new entry in a class attribute description table.

33. A method according to claim 32, wherein step g) includes the additional step of making a database table for each of the classes specified in the class description table.
